(19) United States
(12) Patent Application Publication
(10) Pub. No.: US 2022/0159984 A1
(43) Pub. Date: May 26, 2022

(54) DEFATTED ANIMAL DAIRY PRODUCTS SUPPLEMENTED WITH MICROBIAL ANAPLEROTIC OIL

(71) Applicant: HELIAE DEVELOPMENT, LLC, Gilbert, AZ (US)

(72) Inventors: Magdalena Amezquita Ernult, Phoenix, AZ (US); Lawrence Johnson, Gilbert, AZ (US); Micheal J. LaMont, Gilbert, AZ (US); Eric Lichtenheld, Gilbert, AZ (US); Stephen Ventre, Mesa, AZ (US); Yan Xu, Tempe, AZ (US)

(21) Appl. No.: 17/531,401

(22) Filed: Nov. 19, 2021

Related U.S. Application Data
(60) Provisional application No. 63/116,600, filed on Nov. 20, 2020.
(60) Provisional application No. 63/172,944, filed on Apr. 9, 2021.

(51) Int. Cl. A23C 9/152; A23C 9/127

(52) U.S. Cl. CPC A23C 9/1528; A23C 9/127; A23C 2210/254; A23C 2210/258; A23C 2220/208

(57) ABSTRACT

The present invention provides a method of preparing a defatted animal dairy product enriched with microbial anaplerotic oil and animal dairy products rich in odd-chain fatty acids for consumption by human and non-human animals. Also provided are animal dairy products rich in odd-chain fatty acids (OCFA) for consumption by human and non-human animals, the animal dairy product comprising defatted raw animal milk and microbial anaplerotic oil rich in OCFA.

### CROSS REFERENCE TO RELATED APPLICATIONS

This application claims the benefit of U.S. Provisional Patent Application No. 63/116,600, filed Nov. 20, 2020, and U.S. Provisional Patent Application No. 63/172,944, filed Apr. 9, 2021, each application entitled DEFATTED ANIMAL DAIRY PRODUCTS SUPPLEMENTED WITH MICROBIAL ANAPLEROTIC OIL. The entire contents of each of the foregoing applications are incorporated by reference herein.

### TECHNICAL FIELD

The present invention relates to methods of preparing a defatted animal dairy product enriched with microbial anaplerotic oil and animal dairy product rich in odd-chain fatty acids (OCFA) for consumption by human and non-human animals.

### BACKGROUND

Like all food fats, milk fat mainly consists of triglycerides (98%), which are triesters of fatty acids and glycerol. Milk fat is characterized by a large variety of fatty acids and by a large variety of triglycerides which are combinations of these fatty acids. However, most of these fatty acids are even-chain saturated fatty acids. Milk fat and dairy products which are rich in milk fat (such as butter, cream, and cheeses) suffer from a bad nutritional image because of their high saturated fatty acid.

Raw milk is also derived from animal sources and contains cholesterol. Nutritional recommendations suggest that cholesterol intake be limited. Consequently, improving the nutritional value of milk fat also involves reducing its cholesterol content.

Odd-chain fatty acids (OCFAs) are known to have potential health benefits including, but not limited to, reduction of incidence of type 2 diabetes, heart disease, and stroke as well as reducing incidence of neurodegenerative diseases such as Alzheimer's disease and Lou Gehrig's disease. A need exists for a natural and cost-effective source of OCFAs, particularly C15:0 and C17:0 (two long odd-chain fatty acids), that may be incorporated into animal dairy products to replace the cholesterol and even-chain saturated fatty acids in these products.

### SUMMARY

The present invention provides a method of preparing a defatted animal dairy product enriched with microbial anaplerotic oil, the method comprising: obtaining raw animal milk; defatting the raw animal milk; optionally, pasteurizing the defatted raw animal milk; and adding microbial anaplerotic oil to the defatted milk to produce an OCFA-enriched dairy product.

In certain aspects, defatting the raw animal milk comprises removing tetradecanoic (C14:0) acid, hexadecenoic (C16:0) acid, octadecanoic (C18:0) acid, or a combination thereof. In other aspects, defatting the raw animal milk comprises removing at least 5% of at least one saturated fatty acid from the raw animal milk. In other aspects, adding microbial anaplerotic oil comprises adding odd-chain fatty acids to a final concentration of between about 1% and about 100% of the total fat in the OCFA-enriched dairy product.

In some aspects, the method further comprises skimming the milk to separate skim milk from cream. In one aspect, a mixture of the microbial anaplerotic oil with animal milk fat from the cream is prepared. In certain aspects, the mixture comprises a ratio of animal milk fat to microbial anaplerotic oil of between 0.1:1000 and 1000:0.1, between 0.1:500 and 500:0.1, 0.1:250 and 250:0.1, or 0.1:100 and 100:0.1. In other aspects, the ratio of animal milk fat to microbial anaplerotic oil is about 15:85, about 30:70, about 50:50, about 67:33, about 72:28, about 75:25, about 78:22, about 80:20, or about 85:15. In some aspects, the mixture is added back to the skim milk. In other aspects, the mixture is used to produce cheese, butter, or curd.

In certain aspects, the method further comprises fermenting the milk with lactic acid bacteria and/or a probiotic. In one aspect, the OCFA-enriched dairy product is a yogurt.

In some implementations, the method further comprises demineralizing the milk. In one implementation, the OCFA-enriched dairy product is an infant formula product.

In one aspect, the method further comprises treating the (OCFA)-enriched dairy product with lactase to produce a lactose-free dairy product.

In some aspects, adding microbial anaplerotic oil comprises mixing the microbial anaplerotic oil and the defatted milk to produce a stable emulsion.

In other aspects, the microbial anaplerotic oil comprises saturated odd chain fatty acids selected from the group consisting of tridecanoic (C13:0) acid, pentadecanoic (C15:0) acid, heptadecanoic (C17:0) acid, and combinations thereof.

In certain aspects, the microbial anaplerotic oil is derived from microorganisms of the class Labyrinthuloycetes. In one aspect, the microorganisms of the class Labyrinthuloycetes are thraustochytrid microalgae. In one implementation, the thraustochytrid microalgae are Aurantiochytrium sp. In another implementation, the thraustochytrid microalgae are Aurantiochytrium acetophilum HS399 having Accession No. NCMA 201909001. In another implementation, the microbial anaplerotic oil is microencapsulated. In another implementation, the OCFA-enriched dairy product is homogenized.

In some aspects, the method further comprises adding a gelling agent, a thickening agent, a taste additive, an emulsification agent, or a combination thereof to the OCFA-enriched dairy product. In other aspects, the method further comprises adding docasoahexaenoic acid (DHA), eicosapentaenoic acid (EPA), or a combination thereof to the OCFA-enriched dairy product. In one aspect, the OCFA-enriched dairy product is pasteurized after adding the microbial anaplerotic oil.

The present invention also provides an animal dairy product rich in odd-chain fatty acids (OCFA) for consumption by human and non-human animals, the animal dairy product comprising defatted raw animal milk and microbial anaplerotic oil rich in odd-chain fatty acids (OCFA). In one aspect, the microbial anaplerotic oil comprises saturated odd chain fatty acids selected from the group consisting of tridecanoic (C13:0) acid, pentadecanoic (C15:0) acid, heptadecanoic (C17:0) acid, and combinations thereof.

In another aspect, the present invention relates to an animal dairy product comprising odd-chain fatty acids (OCFA) for consumption by human and non-human animals, the animal dairy product comprising defatted raw animal milk and microbial anaplerotic oil containing OCFA.

In one aspect, the dairy product has been treated with lactase to produce a lactose-free dairy product.

In certain aspects, the animal dairy product is milk, cheese, butter, curd, yogurt, cream cheese, cream, ice cream, or an infant formula product. In other aspects, the animal dairy product further comprises a gelling agent, a thickening agent, a taste additive, and emulsification agent, or a combination thereof.

In one aspect, the gelling agent and/or thickening agent is gelatin, a carrageenan, a locust bean gum, an alginate, a pectin, a xanthan gum or a mixture or an association thereof. In another aspect, the emulsification agent is a monoglyceride, diglyceride, acacia gum, lecithin, or a combination thereof.

In other aspects, the animal dairy product further comprises docasoahexaenoic acid (DHA), eicosapentaenoic acid (EPA), or a combination thereof.

In another aspect, the animal dairy product is homogenized.

### BRIEF DESCRIPTION OF THE DRAWINGS

FIG. 1 depicts the fatty acids profiles of goat, sheep, and cow milk (Markiewicz-Kȩszycka et al., 2013). Although C15:0 and C17:0 fatty acids are not shown in this figure, they are typically present in relatively low levels (see, e.g., the levels of C15:0 and C17:0 fatty acids detected in bovine milk shown in Table 4).

FIG. 2 depicts the fatty acids profile of a thraustochytrid.

FIG. 3 depicts milk products and their production relationships.

FIG. 4A depicts a histogram of Nile Red positive particles sorted by size in homogenized whole milk (control) and in homogenized skim milk containing 3% microbial anaplerotic oil. FIG. 4B depicts a histogram of Nile Red positive particles sorted by size in homogenized reduced fat (i.e., 2%) milk (control) and in homogenized skim milk containing 2% microbial anaplerotic oil.

### DETAILED DESCRIPTION

As used herein and in the appended claims, the singular forms “a,” “an,” and “the” include plural referents unless the context clearly dictates otherwise. For example, “a” or “an” means “at least one” or “one or more.”

The term “milk” is to be interpreted as milk originating from any milk producing mammal, said milk being conventionally used in dairies for the production of dairy products. Accordingly, the term “milk” comprises milk originating from e.g. a cow, a goat, a sheep, a yak, a (water) buffalo, or a camel. Milk from a cow, a goat or a buffalo is preferred.

As used herein, the term “lactose-free” means that the lactose content of, for example, an ice cream formulation or a dairy component thereof (e.g., milk or cream) is about 0.5% or less by weight. Thus, a lactose-free ice cream formulation may contain no detectable lactose, or may contain lactose at a concentration that is less than about 0.50% by weight (e.g., about 0.45%, 0.40%, 0.35%, 0.30%, 0.25%, 0.20%, 0.19%, 0.18%, 0.17%, 0.16%, 0.15%, 0.14%, 0.13%, 0.12%, 0.11%, 0.10%, 0.09%, 0.08%, 0.07%, 0.06%, 0.05%, 0.04%, 0.03%, 0.02%, or 0.01% by weight, about 0.4% to about 0.5% by weight, about 0.3% to about 0.4% by weight, about 0.2% to about 0.3% by weight, about 0.1% to about 0.2% by weight, up to about 0.5% by weight, up to about 0.4% by weight, up to about 0.3% by weight, up to about 0.2% by weight, or up to about 0.1% by weight). In some cases, the dairy ingredients (e.g., milk and/or cream) utilized in the formulae provided herein can contain less than 0.50% lactose by weight (e.g., less than 0.10%, less than 0.05%, or less than 0.01% lactose by weight). Lactose can be detected and/or measured using methods such as, for example, high pressure liquid chromatography (HLPC), or using a blood glucose meter (see, e.g., Metzger, Agriculture Utilization Research Institute, 2013; available at auri.org/research-reports/rapid-measurement-of-the-lactose-content-of-cheese-whey-and-process-cheese-using-a-commercially-available-blood-glucose-meter/) or a LACTOSENS® biosensor (CHR-Hansen; Horsholm, Denmark).

The term “microbial anaplerotic oil rich in odd-chain fatty acids” as used herein refers to an oil containing tridecanoic (C13:0) acid, pentadecanoic (C15:0) acid, heptadecanoic (C17:0) acid, or a combination thereof purified or semi-purified from a microorganism cultured under laboratory or commercial conditions.

Throughout this disclosure, various aspects of the claimed subject matter are presented in a range format. It should be understood that the description in range format is merely for convenience and brevity and should not be construed as an inflexible limitation on the scope of the claimed subject matter. Accordingly, the description of a range should be considered to have specifically disclosed all the possible sub-ranges as well as individual numerical values within that range. For example, where a range of values is provided, it is understood that each intervening value, between the upper and lower limit of that range and any other stated or intervening value in that stated range is encompassed within the claimed subject matter. The upper and lower limits of these smaller ranges may independently be included in the smaller ranges, and are also encompassed within the claimed subject matter, subject to any specifically excluded limit in the stated range. Where the stated range includes one or both of the limits, ranges excluding either or both of those included limits are also included in the claimed subject matter. This applies regardless of the breadth of the range.

### Defatting of Animal Milk

The term “animal milk” refers to milk obtained from a female mammal including, but not limited to, a cow, goat, or ewe. Animal milk is a mixture that consists of 90% water and of various other constituents that can be divided into three categories. The first category, known as “lactoserum” (or whey), consists of carbohydrates, soluble proteins, minerals, and water-soluble vitamins. The second category, known as the “lipid phase” (or cream), contains fatty materials in the form of an emulsion. The third category, known as the “protein phase”, consists of approximately 80% caseins, which form a group of proteins that can be precipitated at pH 4.6 or through the effect of rennet, an enzymatic coagulant, in the presence of calcium. The various caseins form a colloidal micellar complex that can reach diameters on the order of 0.5 μm, with phosphocalcic salts that can be present, for example, in the form of aggregates (“clusters”) of tricalcium phosphate, i.e. Ca₉(PO₄)₆. Such micelles consist of casein subunits made of a hydrophilic layer rich in K-casein surrounding a hydrophobic core, with the phosphocalcic salts being bound to the hydrophilic layer through electrostatic interactions. These phosphocalcic salts may also be present in the internal volume of the micelle, without being bound to the casein. This protein phase also contains soluble proteins, such as lactalbumins and lactoglobulins, as well as albumins and immunoglobulins from blood.

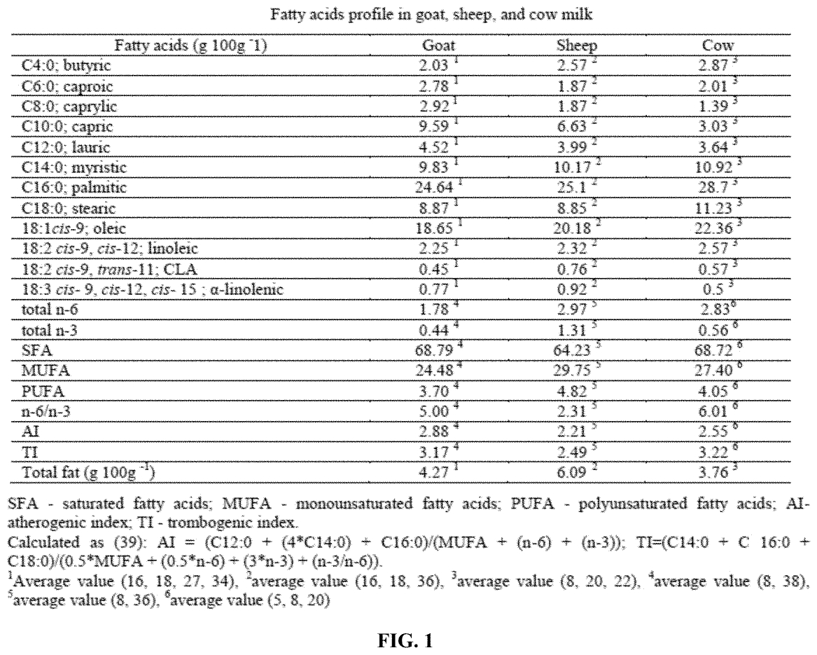

Animal milk derived from various mammals will have different amounts of saturated and unsaturated fatty acids. Representative fatty acid profiles of milk produced by goats, sheep, and cows are presented in FIG. 1. In certain aspects, the defatting step removes a portion of these fatty acids. For example, the defatting step removes at least 1%, at least 5%, at least 10%, at least 20%, at least 30%, at least 40%, at least 50%, at least 60%, at least 70%, at least 80%, at least 90%, at least 95%, at least 96%, at least 97%, at least 98%, or at least 99% of at least one saturated fatty acid from the animal milk. In other aspects, the defatting step removes between 1% and 100%, between 5% and 100%, between 10% and 100%, between 20% and 100%, between 30% and 100%, between 40% and 100%, between 50% and 100%, between 60% and 100%, between 70% and 100%, between 80% and 100%, or between 90% and 100% of at least one saturated fatty acid from the animal milk. In one aspect, the at least one fatty acid is tetradecanoic (C14:0) acid. In another aspect, the at least one fatty acid is hexadecenoic (C16:0) acid. In another aspect, the at least one fatty acid is octadecanoic (C18:0) acid.

Depending on the natural fluidity of the mammalian milk in question, it may be advantageous to fluidize the milk prior to the skimming and defatting step. However, even in the case of dense milks, the fluidization step is purely optional. This fluidization step may be performed by adding an aqueous solvent to the raw milk. For example, the aqueous solvent may be a phosphate salt based solution with a concentration lower than 100 mM, the pH of which is between 7.5 and 8.5, preferably between 8.0 and 8.3, such as a 30 mM sodium phosphate solution, pH 8.0, which list is not limiting. Such an aqueous solvent may also contain sodium chloride, the maximum concentration of which is about 40 mM. Such solutions maintain the stabilized micellar structure of the milk (casein micelles in suspension).

As used herein, the term “skimming” shall be understood as referring to the separation of the fatty matter of the milk, so as to obtain two fractions, i.e., the skim milk and the cream. Skimming can be performed, for example, using a skimmer or by means of organic solvents such as trichloroacetic acid, which is not limiting. In one embodiment, the skimming of the milk is performed by filtration through a glass fiber support with a positive zeta potential. As an example of such a filter, reference may be made to the Ultipor® GF Plus filter as well as to HP series Supradisk filters or AKS active charcoal series (Pall Life Science), GF filters (Whatman), VR Zetaplus filters or Delipid filters (Cuno 3M). The Ultipor® GF Plus filter (Pall) with a 1 μm threshold and the deep filter VR02 or VR04 (Pall) are advantageously used.

This filtration step also makes it possible to de-fat the fraction, that is, to remove the lipids, such as the fatty acids, glycerides, and sterols. This defatting can be accomplished via frontal filtration of the milk through the Ultipor® GF Plus filter after having allowed the diluted milk to stand for 30 minutes (such that the fatty matter floats to the surface, thereby optimizing the separation of the cream from the milk).

In certain aspects, the process of defatting the milk involves centrifugation of the raw animal milk. In one aspect, the raw animal milk is centrifuged at about 1000×g, 1500×g, 2000×g, 2500×g, 3000×g, 3500×g, 4000×g, 4500×g, or 5000×g. In another aspect, the centrifugation occurs at a cool temperature, for example, at about 1° C. to about 15° C., at about 1° C. to about 10° C., at about 1° C. to about 7.5° C., or at about 1° C. to about 5° C. After centrifugation, the animal milk fat is removed from the top of the milk.

As used herein, “defatted milk” refers to milk having a reduced fat content compared to whole milk. Typically, the fat content of the defatted milk is in the range of 0-2 wt %, 0-1 wt %, 0-0.2 wt %, or 0-0.05 wt %, based on total weight of the defatted milk. In one embodiment, the defatted milk is skim milk. The present process employs animal milk, which refers to non-human milk, preferably cow's milk. In one embodiment, the disclosed process comprises a step of defatting milk to obtain the defatted animal milk. Herein, non-defatted animal milk, or just animal milk or whole animal milk, is subjected to the defatting step. The defatting step affords the defatted animal milk.

The incoming milk, prior to or after being defatted, typically after a defatting step, may be subjected to debacterization (bacterial removal), e.g., by UV treatment, heat treatment (e.g., microwave heating, pasteurization, such as HTST, ESL or UHT, or sterilization, for example dry heat or moist heat sterilization) or by bacterial filtration (e.g., microfiltration). In one embodiment, the incoming milk is subjected to pasteurization.

In certain aspects, the OCFA-enriched dairy product is prepared by pasteurizing the raw animal milk using, for example, High Temperature Short Time (HTST) or Ultra High Temperature (UHT) pasteurization as described below. Afterwards, the milk goes through a defatting process to standardize the fat content. The raw whole fat milk is defatted to provide skim milk and subsequently the corresponding amount of fat is added to produce 1%, 2% or whole fat milk. This defatting can be done with gravity by either leaving the milk in tanks to settle or though centrifugation (e.g., centrifugation at 5,000-10,000×g which can help remove bacteria). In some cases, pasteurization comes after standardization of fat content, where the facility needs to cool down the milk before processing it further.

After this process, additives, such as vitamins A and D as well as oils (e.g., microbial anaplerotic oil) can be added to fortify the milk. In certain aspects, the oils are added as emulsions and preferably microencapsulated. Examples of methods of microencapsulation are provided below.

The milk is then homogenized and packaged ensuring protection from oxygen and light ideally to prevent oils and other labile compounds from degrading. A description of the addition of microbial anaplerotic oil to animal dairy products including 1% and 2% milk is provided in Examples 1 and 2.

### Pasteurization of Animal Milk

Pasteurization is used to kill harmful pathogenic bacteria by heating the animal milk for a short time and then immediately cooling it. Types of pasteurized milk include full cream, reduced fat, skim milk, calcium enriched, flavored, and UHT. The standard high temperature short time (HTST) process of 72° C. for 15 seconds completely kills pathogenic bacteria in milk, rendering it safe to drink for up to three weeks if continually refrigerated.

A side effect of the heating of pasteurization is that some vitamin and mineral content is lost. Soluble calcium and phosphorus decrease by 5%, thiamin and vitamin B12 by 10%, and vitamin C by 20%. Because losses are small in comparison to the large amount of the two B-vitamins present, milk continues to provide significant amounts of thiamin and vitamin B12.

### Filtration of Animal Milk

Microfiltration is a process that partially replaces pasteurization and produces milk with fewer microorganisms and longer shelf life without a change in the taste of the milk. In this process, cream is separated from the skimmed milk and is pasteurized in the usual way, but the skimmed milk is forced through ceramic microfilters that trap 99.9% of microorganisms in the milk (as compared to 99.999% killing of microorganisms in standard HTST pasteurization). The skimmed milk then is recombined with the pasteurized cream to reconstitute the original milk composition.

Ultrafiltration uses finer filters than microfiltration, which allow lactose and water to pass through while retaining fats, calcium and protein.] As with microfiltration, the fat may be removed before filtration and added back in afterwards. Ultrafiltered milk is used in cheesemaking, since it has reduced volume for a given protein content, and is sold directly to consumers as a higher protein, lower sugar content, and creamier alternative to regular milk.

### Creaming and Homogenization of Animal Milk

Upon standing for 12 to 24 hours, fresh milk has a tendency to separate into a high-fat cream layer on top of a larger, low-fat milk layer. Alternatively, the separation of the cream from the milk is accomplished rapidly in centrifugal cream separators. The fat globules rise to the top of a container of milk because fat is less dense than water.

The smaller the globules, the more other molecular-level forces prevent this from happening. The cream rises in cow's milk much more quickly than a simple model would predict: rather than isolated globules, the fat in the milk tends to form into clusters containing about a million globules, held together by a number of minor whey proteins. These clusters rise faster than individual globules can.

In certain aspects, the animal milk is homogenized, a treatment that prevents a cream layer from separating out of the milk. The milk is pumped at high pressures through very narrow tubes, breaking up the fat globules through turbulence and cavitation. A greater number of smaller particles possess more total surface area than a smaller number of larger ones, and the original fat globule membranes cannot completely cover them. Casein micelles are attracted to the newly exposed fat surfaces.

Nearly one-third of the micelles in the milk end up participating in this new membrane structure. The casein weighs down the globules and interferes with the clustering that accelerated separation. The exposed fat globules are vulnerable to certain enzymes present in milk, which could break down the fats and produce rancid flavors. To prevent this, the enzymes are inactivated by pasteurizing the milk immediately before or during homogenization.

In one aspect, the microbial anaplerotic oil is added to the animal milk after homogenization. In another aspect, the microbial anaplerotic oil is added to the animal milk before homogenization. In some aspects, homogenization of the mixture of microbial anaplerotic oil animal milk facilitates the blending of the microbial anaplerotic oil with the milk to form a stable emulsion.

### UHT of Animal Milk

In some aspects, the animal milk undergoes Ultra Heat Treatment (UHT), a type of milk processing where all bacteria are destroyed with high heat to extend its shelf life for up to 6 months, as long as the package is not opened. Milk is firstly homogenized and then is heated to 138 degrees Celsius for 1-3 seconds. The milk is immediately cooled down and packed into a sterile container. As a result of this treatment, all the pathogenic bacteria within the milk are destroyed, unlike when the milk is just pasteurized. UHT milk does not need to be refrigerated until the package is opened, which makes it easier to ship and store.

### Demineralization of Animal Milk

In certain aspects, the disclosed method comprises a demineralization step, wherein the lactose source (e.g., animal milk), or one or more components thereof, is/are demineralized. Demineralization is particularly preferred for the manufacture of infant formula products, for which it is typically required to lower the mineral content as compared to the incoming milk.

Demineralization of the lactose source may be performed by any technique known in the art, such as electrodialysis, ion exchange, salt precipitation, lactose crystallization, membrane filtration techniques such as nanofiltration, optionally enhanced with diafiltration, or combinations thereof. In a preferred embodiment, demineralization comprises at least one of salt precipitation, electrodialysis, lactose crystallization and ion exchange, optionally in combination with nanofiltration, more preferably demineralization comprises nanofiltration in combination with at least one of salt precipitation, electrodialysis, lactose crystallization and ion exchange. In one embodiment, demineralization comprises at least electrodialysis and/or salt precipitation. In another embodiment, demineralization comprises at least nanofiltration in combination with electrodialysis and/or salt precipitation.

In certain aspects, demineralization is performed such that at least 20 wt %, or preferably 50 wt %, more preferably at least 70 wt % or at least 80 wt %, most preferably at least 90 wt % of the polyvalent ions and/or such that at least 20 wt % of the monovalent ions are removed, more preferably at least 35 wt % or at least 50 wt %, most preferably at least 60 wt % of the monovalent ions, present in the lactose source.

### Lactase Treatment of Animal Milk

In some embodiments, the animal dairy products provided herein can include, without limitation, lactase, one or more dairy ingredients (e.g., cream and/or milk), egg yolks, sugar, and salt. Flavorings also can be added.

In some embodiments, the lactase used in the animal dairy products and methods described herein can be a purified and standardized liquid neutral beta-galactosidase. It is noted that the lactase should comply with recommended specification on food grade enzymes. In some cases, the lactase can be Kluyveromyces lactis lactase (EC 3.2.1.23). The lactase can have, for example, a minimum activity of 1900 Neutral Lactase Units (NLU)/g and/or an average activity of about 2100 NLU/g to about 5200 NLU/g (e.g., about 2100 NLU/g). The average activity can be measured in accordance with the Food Chemicals Codex (FCC), for example, using a method based on a 10-minute hydrolysis of an o-nitrophenyl-beta-D-galactopyranoside (ONPG) substrate at about 30° C. and at a pH of 6.5. The activity of the lactase can depend on a variety of factors, such as pH, temperature, dosage, time, and type of milk, for example. In the methods provided herein, the desired degree of lactose hydrolysis can be achieved by using an appropriate amount of lactase at an appropriate temperature and for an appropriate time. In some embodiments, for example, a suitable amount of lactase (e.g., about 1000 NLU/L to about 2000 NLU/L, about 2000 NLU/L to about 3000 NLU/L, about 3000 NLU/L to about 4000 NLU/L, or more than 4000 NLU/L) can be used to obtain complete or substantially complete hydrolysis of lactose, at a temperature of about 0° C. to about 5° C. (about 32° F. to about 41° F.) for about 12 to 72 hours (e.g., 12 to 24 hours, 24 to 36 hours, 36 to 48 hours, or 48 to 72 hours, or about 12, 24, 36, 48, 60, or 72 hours). In some embodiments, the lactase can be used at a high temperature, such as during Pasteurization (e.g., at about 145° F. to about 180° F., which may be carried out for about 15 seconds to about 30 minutes, or even during ultra-high temperature processing, which may be carried out for 1 to 2 seconds at about 275° F.).

In some embodiments, the dairy ingredient(s) (e.g., cream and/or milk) can be in liquid form, while in other embodiments, the dairy ingredient(s) can be powdered, evaporated, condensed, etc. Dairy in liquid form can be particularly useful for the addition of lactase, because the lactase reaction can be carried out in the natural suspension of the milk and/or cream. Further, using liquid dairy ingredients can allow the addition of lactase to be done at refrigerated temperatures, typically between about 32° F. and about 41° F. (thus, above freezing), which will not affect the composition of the fat molecules in the dairy ingredient(s) prior to pasteurization. If fat molecules are heated frequently, they may denature, preventing strong agglomeration. Thus, preserving the integrity of fat molecules can be crucial in creating a smooth mixture, since intact fat molecules typically can agglomerate more successfully and solidify the structure of the ice cream during freezing.

### Fermentation of Animal Milk

The animal dairy products disclosed herein can be a fermented or non-fermented dairy composition. Fermented products typically comprise microorganisms, such as lactic acid bacteria and/or probiotics (the probiotics can be lactic acid bacteria). These are also referred to as ferments or cultures or starters. Examples of probiotics include some Bifidobacteria and Lactobacilli, such as Bifidobacterium brevis, Lactobacillus acidophilus, Bifidobacterium animalis, Bifidobacterium animalis lactis, Bifidobacterium infantis, Bifidobacterium longum, Lactobacillus casei, Lactobacillus casei paracasei, Lactobacillus reuteri, Lactobacillus plantarum, or Lactobacillus rhamnosus. In one embodiment, the animal dairy product is a fermented milk product or a yogurt.

Fermented animal milk products are made from animal milk with further additives and have undergone a fermentation step. The fermentation is typically done by microorganisms such as bacteria and/or yeasts, preferably at least bacteria, preferably lactic acid bacteria. This leads to the production of fermentation products such as lactic acid and/or to the multiplication of the microorganisms. The designation “fermented milk” can depend on local legislation, but is typically given to a dairy product prepared from skimmed or full fat milk, or concentrated or powdered milk, having undergone a heat treatment at least equivalent to a pasteurization treatment, and inoculated with lactic acid producing microorganisms such as Lactobacilli (e.g., Lactobacillus acidophilus, Lb. casei, Lb. plantarum, Lb. reuteri, Lb. johnsonii), certain Streptococci (e.g., Streptococcus thermophilus), Bifidobacteria (e.g., Bifidobacterium bifidum, B. longum, B. breve, B. animalis) and/or Lactococci (e.g., Lactococcus lactis).

In one aspect, the animal dairy product is a fermented composition. The fermented composition may comprise lactic acid bacteria. In one embodiment, the lactic acid bacteria comprise a mixture of Streptococcus thermophilus and Lactobacillus delbrueckii subsp. Bulgaricus.

A variety of dairy products can be made using the methods and compositions of the present invention. Such dairy products include without limitation, milk, whole milk, buttermilk, skim milk, infant formula, condensed milk, dried milk, evaporated milk, butter, clarified butter, cream and various types of cheese. The dairy products can also be incorporated into various food applications, which include the following ice cream, frozen custard, frozen yogurt, cookies, cakes, cottage cheese, cream cheese, creme fraiche, curds and yogurt. Preparation of several of these dairy products using the methods and compositions of the present invention is described below.

In some aspects, the dairy products disclosed herein are fresh. In other aspects, the dairy products are frozen. In one aspect, the dairy product comprises a dried product (e.g., powdered milk).

In some implementations, the dairy products disclosed herein provide at least 0.01 g, at least 0.05 g, at least 0.1 g, at least 0.2 g, at least 0.3 g, at least 0.4 g, at least 0.5 g, at least 0.6 g, at least 0.7 g, at least 0.8 g, at least 0.9 g, at least 1 g, at least 2 g, at least 3 g, at least 4 g, at least 5 g, at least 6 g, at least 7 g, at least 8 g, at least 9 g, at least 10 g of odd-chain saturated fatty acids per daily serving.

In other implementations, the dairy products disclosed herein provide between about 0.01 g and 10 g, between about 0.01 g and 9 g, between about 0.01 g and 8 g, between about 0.01 g and 7 g, between about 0.01 g and 6 g, between about 0.01 g and 5 g, between about 0.01 g and 4 g, between about 0.01 g and 3 g, between about 0.01 g and 2 g, between about 0.01 g and 1 g, or between about 0.01 g and 0.1 g of odd-chain saturated fatty acids per daily serving.

Various types of milk have a fat content ranging from about 0.1 g to about 8 g per about 240 g (i.e., 1 cup). In various implementations, about 1%, about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 100% of this fat is odd-chain saturated fatty acids (e.g., tridecanoic (C13:0) acid, pentadecanoic (C15:0) acid, and/or heptadecanoic (C17:0) acid).

In some implementations, between about 1% and about 100%, between about 1% and about 90%, between about 1% and about 80%, between about 1% and about 70%, between about 1% and about 60%, between about 1% and about 50%, between about 1% and about 40%, between about 1% and about 30%, between about 1% and about 20%, between about 1% and about 10%, between about 1% and about 5%, between about 10% and about 100%, between about 10% and about 90%, between about 10% and about 80%, between about 10% and about 70%, between about 10% and about 60%, between about 10% and about 50%, between about 10% and about 40%, between about 10% and about 30%, between about 10% and about 20%, between about 25% and about 100%, between about 25% and about 90%, between about 25% and about 80%, between about 25% and about 70%, between about 25% and about 60%, between about 25% and about 50%, between about 25% and about 40%, between about 25% and about 30%, between about 50% and about 100%, between about 50% and about 90%, between about 50% and about 80%, between about 50% and about 70%, or between about 50% and about 60% of this fat is odd-chain saturated fatty acids (e.g., tridecanoic (C13:0) acid, pentadecanoic (C15:0) acid, and/or heptadecanoic (C17:0) acid).

In certain aspects, the cholesterol in the OCFA-enriched animal dairy products disclosed herein is reduced by at least 1%, at least 5%, at least 10%, at least 15%, at least 20%, at least 25%, at least 30%, at least 35%, at least 40%, at least 45%, at least 50%, at least 60%, at least 70%, at least 80%, at least 90%, at least 95% at least 96%, at least 97%, at least 98%, or at least 99% compared to the cholesterol in the raw animal milk prior to defatting and supplementation with OCFA.

In other aspects, the cholesterol in the OCFA-enriched animal dairy products disclosed herein is between about 1% and about 99%, between about 10% and about 99%, between about 20% and about 99%, between about 30% and about 99%, between about 40% and about 99%, between about 50% and about 99%, between about 60% and about 99%, between about 70% and about 99%, between about 80% and about 99%, or between about 90% and about 99% of the cholesterol in the raw animal milk prior to defatting and supplementation with OCFA.

### Cheesemaking

### Process

The process of cheesemaking involves controlling the spoiling of milk into cheese. The milk is traditionally from a cow, goat, sheep or buffalo. The goal is a consistent product with specific characteristics and organoleptic requirements (appearance, aroma, taste, texture). Some cheeses are deliberately left to ferment from naturally airborne spores and bacteria; this approach generally leads to a less consistent product. For the dairy products of the present invention, the raw animal milk is defatted or partially defatted prior to the subsequent steps required for cheesemaking.

### Culturing

To make cheese, one brings milk (possibly pasteurized) in the cheese vat to a temperature required to promote the growth of the bacteria that feed on lactose and thus ferment the lactose into lactic acid. These bacteria in the milk may be wild, as is the case with unpasteurized milk, added from a culture, frozen or freeze-dried concentrate of starter bacteria. Bacteria which produce only lactic acid during fermentation are homofermentative; those that also produce lactic acid and other compounds such as carbon dioxide, alcohol, aldehydes and ketones are heterofermentative. Fermentation using homofermentative bacteria is important in the production of cheeses such as Cheddar, where a clean, acid flavor is required. For cheeses such as Emmental the use of heterofermentative bacteria is necessary to produce the compounds that give characteristic fruity flavors and, importantly, the gas that results in the formation of bubbles in the cheese (‘eye holes’).

One chooses starter cultures to give a cheese its specific characteristics. Also, if one intends to make a mold-ripened cheese such as Stilton, Roquefort or Camembert, mold spores (fungal spores) may be added to the milk in the cheese vat or can be added later to the cheese curd.

Coagulation During the fermentation process, once one has gauged that sufficient lactic acid has been developed, rennet is added to cause the casein to precipitate. Rennet contains the enzyme chymosin which converts κ-casein to para-κ-caseinate (the main component of cheese curd, which is a salt of one fragment of the casein) and glycomacropeptide, which is lost in the cheese whey. As the curd is formed, milk fat is trapped in a casein matrix. After adding the rennet, the cheese milk is left to form curds over a period of time.

### Draining

Once the cheese curd is judged to be ready, the cheese whey must be released. As with many foods the presence of water and the bacteria in it encourages decomposition. One must, therefore, remove most of the water (whey) from the cheese milk, and hence cheese curd, to make a partial dehydration of the curd. This ensures a product of good quality that will keep. There are several ways to separate the curd from the whey known in the art. In some implementations, microbial anaplerotic oil is added to cheese curd after draining.

### Scalding

In making Cheddar (or other hard cheeses) the curd is cut into small cubes and the temperature is raised to approximately 39° C. (102° F.) to ‘scald’ the curd particles. Syneresis occurs and cheese whey is expressed from the particles. The Cheddar curds and whey are often transferred from the cheese vat to a cooling table which contains screens that allow the whey to drain, but which trap the curd. In some implementations, microbial anaplerotic oil is added to cheese curd after scalding and draining. The curd is cut using long, blunt knives and ‘blocked’ (stacked, cut and turned) to promote the release of cheese whey in a process known as ‘cheddaring’. During this process the acidity of the curd increases and when it has reached the required level, around 0.65%, the curd is milled into ribbon shaped pieces and salt is mixed into it to arrest acid development. The salted green cheese curd is put into cheese molds lined with cheesecloths and pressed overnight to allow the curd particles to bind together. The pressed blocks of cheese are then removed from the cheese molds and are either bound with muslin-like cloth, or waxed or vacuum packed in plastic bags to be stored for maturation. Vacuum packing removes oxygen and prevents mold (fungal) growth during maturation, which depending on the wanted final product may be a desirable characteristic or not.

### Mold-Ripening

In contrast to cheddaring, making cheeses like Camembert requires a gentler treatment of the curd. It is carefully transferred to cheese hoops and the whey is allowed to drain from the curd by gravity, generally overnight. The cheese curds are then removed from the hoops to be brined by immersion in a saturated salt solution. The salt absorption stops bacteria growing, as with Cheddar. In some implementations, microbial anaplerotic oil is added to cheese curd after brining. If white mold spores have not been added to the cheese milk one applies them to the cheese either by spraying the cheese with a suspension of mold spores in water or by immersing the cheese in a bath containing spores of, e.g., Penicillium candida.

By taking the cheese through a series of maturation stages where temperature and relative humidity are carefully controlled, one allows the surface mold to grow and the mold-ripening of the cheese by fungi to occur. Mold-ripened cheeses ripen very quickly compared to hard cheeses (weeks compared to months or years). This is because the fungi used are biochemically very active when compared with starter bacteria. Some cheeses are surface-ripened by molds, such as Camembert and Brie, some are ripened internally, such as Stilton, which is pierced by the cheesemaker with stainless steel wires, to admit air to promote mold spore germination and growth, as with Penicillium roqueforti. Surface ripening of some cheeses, such as Saint-Nectaire, may also be influenced by yeasts which contribute flavor and coat texture. Others are allowed by the cheesemaker to develop bacterial surface growths which give characteristic colors and appearances, e.g. by the growth of Brevibacterium linens which gives an orange coat to cheeses.

As shown in Table 1, various types of cheese have a fat content ranging from about 4.3 to about 33.1 g per 100 g of cheese. In various implementations, about 1%, about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 100% of this fat is odd-chain saturated fatty acids (e.g., tridecanoic (C13:0) acid, pentadecanoic (C15:0) acid, and/or heptadecanoic (C17:0) acid).

In some implementations, between about 1% and about 100%, between about 1% and about 90%, between about 1% and about 80%, between about 1% and about 70%, between about 1% and about 60%, between about 1% and about 50%, between about 1% and about 40%, between about 1% and about 30%, between about 1% and about 20%, between about 1% and about 10%, between about 1% and about 5%, between about 10% and about 100%, between about 10% and about 90%, between about 10% and about 80%, between about 10% and about 70%, between about 10% and about 60%, between about 10% and about 50%, between about 10% and about 40%, between about 10% and about 30%, between about 10% and about 20%, between about 25% and about 100%, between about 25% and about 90%, between about 25% and about 80%, between about 25% and about 70%, between about 25% and about 60%, between about 25% and about 50%, between about 25% and about 40%, between about 25% and about 30%, between about 50% and about 100%, between about 50% and about 90%, between about 50% and about 80%, between about 50% and about 70%, or between about 50% and about 60% of this fat is odd-chain saturated fatty acids (e.g., tridecanoic (C13:0) acid, pentadecanoic (C15:0) acid, and/or heptadecanoic (C17:0) acid).

TABLE 1
Macronutrients (g) of common cheeses per 100 g.

| Cheese | Water | Protein | Fat | Carbohydrates |
|---|---|---|---|---|
| Swiss | 37.1 | 26.9 | 27.8 | 5.4 |
| Feta | 55.2 | 14.2 | 21.3 | 4.1 |
| Cheddar | 36.8 | 24.9 | 33.1 | 1.3 |
| Mozzarella | 50 | 22.2 | 22.4 | 2.2 |
| Cottage | 80 | 11.1 | 4.3 | 3.4 |

### Yogurt Production

Yogurt is produced by bacterial fermentation of milk. For the dairy products of the present invention, the raw animal milk is defatted or partially defatted prior to the subsequent steps required for preparing yogurt.

The bacteria used to make yogurt are known as yogurt cultures. The fermentation of lactose by these bacteria produces lactic acid, which acts on milk protein to give yogurt its texture and characteristic tart flavor. Cow's milk is commonly available worldwide and, as such, is the milk most commonly used to make yogurt. Milk from water buffalo, goats, ewes, mares, camels, and yaks is also used to produce yogurt where available locally. The milk used may be homogenized or not. It may be pasteurized or raw. Each type of milk produces substantially different results.

Yogurt is generally produced using a culture of Lactobacillus delbrueckii subsp. bulgaricus and Streptococcus thermophilus bacteria. In addition, other lactobacilli and bifidobacteria are sometimes added during or after culturing yogurt. To produce yogurt, milk is first heated, usually to about 85° C. (185° F.), to denature the milk proteins so that they do not form curds. After heating, the milk is allowed to cool to about 45° C. (113° F.). In some implementations, microbial anaplerotic oil is added to the milk after heating and cooling prior to addition of the bacterial culture. The bacterial culture is mixed in, and that temperature of 45° C. is maintained for about 4 to 12 hours to allow fermentation to occur. In other implementations, microbial anaplerotic oil is added after fermentation.

To offset its natural sourness, yogurt is also sold sweetened, sweetened and flavored or in containers with fruit or fruit jam on the bottom. The two styles of yogurt commonly found in the grocery store are set-style yogurt and Swiss-style yogurt. Set-style yogurt is poured into individual containers to set, while Swiss-style yogurt is stirred prior to packaging. Either may have fruit added to increase sweetness.

Lassi is a common Indian beverage made from stirred liquified yogurt that is either salted or sweetened with sugar commonly, less commonly honey and combined with fruit pulp to create flavored lassi.

Large amounts of sugar—or other sweeteners for low-energy yogurts—are often used in commercial yogurt Some yogurts contain added modified starch, pectin (found naturally in fruit) or gelatin to create thickness and creaminess. This type of yogurt may be marketed under the name Swiss-style, although it is unrelated to conventional Swiss yogurt. Some yogurts, often called “cream line”, are made with whole milk which has not been homogenized so the cream rises to the top.

Strained yogurt has been strained through a filter, traditionally made of muslin and more recently of paper or non-muslin cloth. This removes the whey, giving a much thicker consistency. In some implementations, microbial anaplerotic oil is added after straining. Strained yogurt may be preferred, especially if using skimmed milk which results in a thinner consistency. Yogurt that has been strained to filter or remove the whey is known as Labneh in Middle Eastern countries. It has a consistency between that of yogurt and cheese. It can be thickened further and rolled into balls, preserved in olive oil, and fermented for a few more weeks.

Some types of strained yogurts are boiled in open vats first, so that the liquid content is reduced. In North America, strained yogurt is commonly called “Greek yogurt”. Powdered milk is sometimes added in lieu of straining to achieve thickness.

As shown in Table 2, yogurt made from whole milk has a fat content of about 8.5 g per about 245 g (i.e., 1 cup) of yogurt. In various implementations, about 1%, about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 100% of this fat is odd-chain saturated fatty acids (e.g., tridecanoic (C13:0) acid, pentadecanoic (C15:0) acid, and/or heptadecanoic (C17:0) acid).

In some implementations, between about 1% and about 100%, between about 1% and about 90%, between about 1% and about 80%, between about 1% and about 70%, between about 1% and about 60%, between about 1% and about 50%, between about 1% and about 40%, between about 1% and about 30%, between about 1% and about 20%, between about 1% and about 10%, between about 1% and about 5%, between about 10% and about 100%, between about 10% and about 90%, between about 10% and about 80%, between about 10% and about 70%, between about 10% and about 60%, between about 10% and about 50%, between about 10% and about 40%, between about 10% and about 30%, between about 10% and about 20%, between about 25% and about 100%, between about 25% and about 90%, between about 25% and about 80%, between about 25% and about 70%, between about 25% and about 60%, between about 25% and about 50%, between about 25% and about 40%, between about 25% and about 30%, between about 50% and about 100%, between about 50% and about 90%, between about 50% and about 80%, between about 50% and about 70%, or between about 50% and about 60% of this fat is odd-chain saturated fatty acids (e.g., tridecanoic (C13:0) acid, pentadecanoic (C15:0) acid, and/or heptadecanoic (C17:0) acid).

TABLE 2
Comparison of whole milk and plain yogurt
from whole milk, one cup (245 g) each.

| Property | Milk | | Yogurt | |
|---|---|---|---|---|
| Energy | 610 | kJ | 620 | kJ |
| | (146 | kcal) | (149 | kcal) |
| Total carbohydrates | 12.8 | g | 12 | g |
| Total fat | 7.9 | g | 8.5 | g |
| Cholesterol | 24 | mg | 32 | mg |
| Protein | 7.9 | g | 9 | g |

### Butter Production

Butter is a dairy product made from the fat and protein components of milk or cream. Butter is a semi-solid emulsion at room temperature, consisting of approximately 80% butterfat.

Most frequently made from cow's milk, butter can also be manufactured from the milk of other mammals, including sheep, goats, buffalo, and yaks. It is made by churning milk or cream to separate the fat globules from the buttermilk. For the dairy products of the present invention, the raw animal milk is defatted or partially defatted prior to the subsequent steps required for producing butter. Salt and food colorings are sometimes added to butter. Rendering butter, removing the water and milk solids, produces clarified butter or ghee, which is almost entirely butterfat.

Butter is a water-in-oil emulsion resulting from an inversion of the cream, where the milk proteins are the emulsifiers. Unhomogenized milk and cream contain butterfat in microscopic globules. These globules are surrounded by membranes made of phospholipids (fatty acid emulsifiers) and proteins, which prevent the fat in milk from pooling together into a single mass. Butter is produced by agitating cream, which damages these membranes and allows the milk fats to conjoin, separating from the other parts of the cream. Variations in the production method will create butters with different consistencies, mostly due to the butterfat composition in the finished product. Butter contains fat in three separate forms: free butterfat, butterfat crystals, and undamaged fat globules. In the finished product, different proportions of these forms result in different consistencies within the butter; butters with many crystals are harder than butters dominated by free fats.

Churning produces small butter grains floating in the water-based portion of the cream. This watery liquid is called buttermilk—although the buttermilk most common today is instead a directly fermented skimmed milk. The buttermilk is drained off; sometimes more buttermilk is removed by rinsing the grains with water. In some implementations, microbial anaplerotic oil is added after churning and draining of the buttermilk. Then the grains are “worked” or pressed and kneaded together. When prepared manually, this is done using wooden boards called scotch hands. This consolidates the butter into a solid mass and breaks up embedded pockets of buttermilk or water into tiny droplets. In other implementations, microbial anaplerotic oil is added after the grains are pressed and kneaded together.

Commercial butter is about 80% butterfat and 15% water; traditionally made butter may have as little as 65% fat and 30% water. Butterfat is a mixture of triglyceride, a triester derived from glycerol and three of any of several fatty acid groups.

Butter made from a fermented cream is known as cultured butter. During fermentation, the cream naturally sours as bacteria convert milk sugars into lactic acid. The fermentation process produces additional aroma compounds, including diacetyl, which makes for a fuller-flavored and more “buttery” tasting product. Cultured butter is usually made from pasteurized cream whose fermentation is produced by the introduction of Lactococcus and Leuconostoc bacteria. In some implementations, microbial anaplerotic oil is added to cultured butter after pasteurization and/or fermentation.

Another method for producing cultured butter is to produce butter from fresh cream and then incorporate bacterial cultures and lactic acid. Using this method, the cultured butter flavor grows as the butter is aged in cold storage. In certain aspects, this method is more efficient because aging the cream used to make butter takes significantly more space than simply storing the finished butter product. A method to make an artificial simulation of cultured butter is to add lactic acid and flavor compounds directly to the fresh-cream butter; while this more efficient process is claimed to simulate the taste of cultured butter, the product produced is not cultured but is instead flavored.

Dairy products are often pasteurized during production to kill pathogenic bacteria and other microbes. Butter made from pasteurized fresh cream is called sweet cream butter. Butter made from fresh or cultured unpasteurized cream is called raw cream butter. Cultured butter is sometimes labeled “European-style” butter in the United States. Commercial raw cream butter is rare.

Several “spreadable” butters can be produced. These remain softer at colder temperatures and are therefore easier to use directly out of refrigeration. Some methods modify the makeup of the butter's fat through chemical manipulation of the finished product, some manipulate the cattle's feed, and some incorporate vegetable oil into the butter. “Whipped” butter, another product designed to be more spreadable, is aerated by incorporating nitrogen gas.

All categories of butter are prepared in both salted and unsalted forms. Either granular salt or a strong brine are added to salted butter during processing. In addition to enhanced flavor, the addition of salt acts as a preservative. The amount of butterfat in the finished product is a vital aspect of production. In the United States, products sold as “butter” must contain at least 80% butterfat. In practice, most American butters contain slightly more than that, averaging around 81% butterfat. European butters generally have a higher ratio—up to 85%.

### Liquid Clarified Butter

Clarified butter is butter with almost all of its water and milk solids removed, leaving almost-pure butterfat. In some implementations, microbial anaplerotic oil is added after removal of water and milk solids. Clarified butter is made by heating butter to its melting point and then allowing it to cool; after settling, the remaining components separate by density. At the top, whey proteins form a skin, which is removed. The resulting butterfat is then poured off from the mixture of water and casein proteins that settle to the bottom.

Ghee is clarified butter that has been heated to around 120° C. (250° F.) after the water is evaporated, turning the milk solids brown. This process flavors the ghee and produces antioxidants that help protect it from rancidity.

### Whey Butter

Cream may be separated (usually by a centrifugal separator) from whey instead of milk, as a byproduct of cheese-making. Whey butter may be made from whey cream. In some implementations, microbial anaplerotic oil is added to whey butter after separating the cream from the whey. Whey cream and butter have a lower fat content and taste more salty, tangy and “cheesy”. They are also less expensive than “sweet” cream and butter. The fat content of whey is low, so 1000 pounds of whey will typically give 3 pounds of butter.

### Synthetic Butter Replacement

In certain aspects, the animal milk fats (i.e., cream) are used to prepare synthetic butter replacements. In a non-limiting example, a synthetic butter replacement is about 80% water, about 18% vegetable oil, and about 2% milk fat.

As shown in Table 3, about 43 g to about 48 g of saturated fat in present in a total of about 80 g to about 88 g of total fat in butter. In various implementations, about 1%, about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 100% of this saturated fat is odd-chain fatty acids (e.g., tridecanoic (C13:0) acid, pentadecanoic (C15:0) acid, and/or heptadecanoic (C17:0) acid).

In some implementations, between about 1% and about 100%, between about 1% and about 90%, between about 1% and about 80%, between about 1% and about 70%, between about 1% and about 60%, between about 1% and about 50%, between about 1% and about 40%, between about 1% and about 30%, between about 1% and about 20%, between about 1% and about 10%, between about 1% and about 5%, between about 10% and about 100%, between about 10% and about 90%, between about 10% and about 80%, between about 10% and about 70%, between about 10% and about 60%, between about 10% and about 50%, between about 10% and about 40%, between about 10% and about 30%, between about 10% and about 20%, between about 25% and about 100%, between about 25% and about 90%, between about 25% and about 80%, between about 25% and about 70%, between about 25% and about 60%, between about 25% and about 50%, between about 25% and about 40%, between about 25% and about 30%, between about 50% and about 100%, between about 50% and about 90%, between about 50% and about 80%, between about 50% and about 70%, or between about 50% and about 60% of this saturated fat is odd-chain saturated fatty acids (e.g., tridecanoic (C13:0) acid, pentadecanoic (C15:0) acid, and/or heptadecanoic (C17:0) acid).

TABLE 3
Properties of common cooking fats

| | | | Mono- | Poly- | |
|---|---|---|---|---|---|
| | Total | Saturated | unsaturated | unsaturated | Smoke |
| Type of fat | fat (g) | fat (g) | fat (g) | fat (g) | point |
| Butter | 80-88 | 43-48 | 15-19 | 2-3 | 150° C. |
| | | | | | (302° F.) |
| Canola oil | 100 | 6-7 | 62-64 | 24-26 | 205° C. |
| | | | | | (401° F.) |
| Olive oil | 100 | 13-19 | 59-74 | 6-16 | 190° C. |
| | | | | | (374° F.) |
| Soybean oil | 100 | 15 | 22 | 57-58 | 257° C. |
| | | | | | (495° F.) |
| Vegetable | 100 | 25 | 41 | 28 | 165° C. |
| shortening | | | | | (329° F.) |

### Additives to Animal Dairy Products

In some aspects, the dairy products disclosed herein comprise a gelling and/or thickening agent. The gelling and/or thickening agent can be, for example, gelatin, a carrageenan, a locust bean gum, an alginate, a pectin, a xanthan gum or a mixture or an association thereof. In one embodiment the gelling and/or thickening agent is gelatin. In one embodiment the gelling and/or thickening agent is xanthan gum. In one embodiment the gelling and/or thickening agent is a mixture or an association of gelatin and xanthan gum. In some embodiments the gelling and/or thickening agent is a carrageenan, a locust bean gum, an alginate, or a pectin.

In other aspects, the dairy products disclosed herein comprises taste additives. Such additives may include flavors, perfumes, fruits or fruit extracts, nuts, sweetening agents, or acidity modifiers. In one embodiment, the taste additive comprises chocolate or cacao. In another embodiment, the taste additive comprises sugar. Beyond modifying taste, sugar can contribute to increasing the dry matter of the composition. The sugar can be, for example glucose, fructose, lactose, sucrose, saccharose, galactose, maltose, mannose, dextrose or a mixture thereof.

In one aspect, the dairy products disclosed herein comprise an emulsifier. The emulsifier is preferably selected from the group consisting of monoglycerides, diglycerides, acacia gum, lecithin, and a combination thereof. Advantageously, these emulsifiers are helpful in the homogenization process to form a good emulsion with stable fat droplets having very small average diameters. In one aspect, the dairy products comprise from about 0.1% to 1.0%, from about 0.1% to 0.9%, from about 0.1% to 0.8%, from about 0.1% to 0.7%, from about 0.1% to 0.6%, from about 0.1% to 0.5%, from about 0.1% to 0.4%, from about 0.1% to 0.3%, or from about 0.1% to 0.2% of an emulsifier.

In some aspects, the dairy products disclosed herein comprise further ingredients including salts, non-fat milk solids, stabilizers, emulsifiers, flavorants, spices, proteins, water, acidifying components, alkalinizing components or any combination thereof.

In certain aspects, the dairy products disclosed herein comprise at least one flavorant selected from the group consisting of: δ-decalactone, ethyl butyrate, 2-furyl methyl ketone, 2,3-pentanedione, γ-undecalactone, and δ-undecalactone. In certain aspects, the dairy products disclosed herein comprise one or more sweetening agents (e.g., a saccharide). In some aspects, the saccharide is selected from the group consisting of: glucose, mannose, maltose, fructose, galactose, lactose, sucrose, monatin, and tagatose. In some aspects, the one or more sweetening agents is an artificial sweetener. In certain aspects, the artificial sweetener is selected from the group of: stevia, aspartame, cyclamate, saccharin, sucralose, mogrosides, brazzein, curculin, erythritol, glycyrrhizin, inulin, isomalt, lacititol, mabinlin, malititol, mannitol, miraculin, monatin, monelin, osladin, pentadin, sorbitol, thaumatin, xylitol, acesulfame potassium, advantame, alitame, aspartame-acesulfame, sodium cyclamate, dulcin, glucin, neohesperidin dihyrdochalcone, neotame, and P-4000.

In some aspects, the dairy products disclosed herein comprise one or more color balancing agents. In certain aspects, the one or more color balancing agents is β-carotene or annatto. In some aspects, the dairy products disclosed herein have a pH of about 6.2 to about 7.2 (e.g., about 6.2 to about 6.8).

In other aspects, the dairy products disclosed herein comprise docasoahexaenoic acid (DHA), eicosapentaenoic acid (EPA), or a combination thereof. The DHA and EPA can be from any natural and/or organic source, such as plants and/or animals. One source of omega-3 fatty acids, such as DHA, includes an animal source. Examples of animal sources include aquatic animals (e.g., fish, marine mammals, and crustaceans such as krill and other euphausids) and animal tissues (e.g., brain, liver, eyes, etc.) and animal products such as eggs or milk. DHA and EPA can be purified to various levels. Such a purification can be achieved by any means known to those of skill in the art.

### Sources of Microbial Anaplerotic Oil

The dairy products disclosed herein comprise microbial anaplerotic oil rich in odd-chain fatty acids. The microbial source of the anaplerotic oil can be Aurantiochytrium, a thraustochytrid, or another species of microorganism including microalgae, yeast, fungi, and bacteria.

In some aspects, the microbial anaplerotic oil is derived from fungi. The fungi include, but are not limited to, fungi of the genera Blakeslea, Candida, Cryptococcus, Cunninghamella, Lipomyces, Mortierella, Mucor, Phycomyces, Pythium, Rhodosporidium, Rhodotorula, Trichosporon, Yarrowia, Aspergillus, Botrytis, Cercospora, Fusarium (Gibberella), Kluyveromyces, Neurospora, Penicillium, Pichia (Hansenula), Puccinia, Saccharomyces, Schizosaccharomyces, Sclerotium, Trichoderms, Ustilago, and Xanthophyllomyces (Phaffia). In certain aspects, the fungi are of a species including, but not limited to, Cryptococcus neoformans, Fusarium fujikuroi, Kluyverimyces lactis, Neurospora crassa, Saccharomyces cerevisiae, Schizosaccharomyces pombe, Ustilago maydis, and Yarrowia hpolytica.

In some aspects, the microbial anaplerotic oil is derived from microalgae. The term “microalgae” as used herein refers to microscopic single cell organisms such as microalgae, cyanobacteria, algae, diatoms, dinoflagellates, freshwater organisms, marine organisms, or other similar single cell organisms capable of growth in phototrophic, mixotrophic, or heterotrophic culture conditions.

Non-limiting examples of microalgae that can be used in the compositions and methods of the claimed subject matter comprise microalgae in the classes: Eustigmatophyceae, Chlorophyceae, Prasinophyceae, Haptophyceae, Cyanidiophyceae, Prymnesiophyceae, Porphyridiophyceae, Labyrinthulomycetes, Trebouxiophyceae, Bacillariophyceae, and Cyanophyceae. The class Cyanidiophyceae includes species of Galdieria. The class Chlorophyceae includes species of Chlorella, Haematococcus, Scenedesmus, Chlamydomonas, and Micractinium. The class Prymnesiophyceae includes species of Isochrysis and Pavlova. The class Eustigmatophyceae includes species of Nannochloropsis. The class Porphyridiophyceae includes species of Porphyridium. The class Labyrinthulomycetes includes species of Schizochytrium and Aurantiochytrium. The class Prasinophyceae includes species of Tetraselmis. The class Trebouxiophyceae includes species of Chlorella. The class Bacillariophyceae includes species of Phaeodactylum. The class Cyanophyceae includes species of spirulina.

Non-limiting examples of microalgae genus and species that can be used in the compositions and methods of the claimed subject matter include: Achnanthes orientalis, Agmenellum spp., Amphiprora hyaline, Amphora coffeiformis, Amphora coffeiformis var. linea, Amphora coffeiformis var. punctata, Amphora coffeiformis var. taylori, Amphora coffeiformis var. tenuis, Amphora delicatissima, Amphora delicatissima var. capitata, Amphora sp., Anabaena, Ankistrodesmus, Ankistrodesmus falcatus, Aurantiochytrium sp., Boekelovia hooglandii, Borodinella sp., Botryococcus braunii, Botryococcus sudeticus, Bracteococcus minor, Bracteococcus medionucleatus, Carteria, Chaetoceros gracilis, Chaetoceros muelleri, Chaetoceros muelleri var. subsalsum, Chaetoceros sp., Chlamydomonas sp., Chlamydomas perigranulata, Chlorella anitrata, Chlorella antarctica, Chlorella aureoviridis, Chlorella Candida, Chlorella capsulate, Chlorella desiccate, Chlorella ellipsoidea, Chlorella emersonii, Chlorella fusca, Chlorella fusca var. vacuolate, Chlorella glucotropha, Chlorella infusionum, Chlorella infusionum var. actophila, Chlorella infusionum var. auxenophila, Chlorella kessleri, Chlorella lobophora, Chlorella luteoviridis, Chlorella luteoviridis var. aureoviridis, Chlorella luteoviridis var. lutescens, Chlorella miniata, Chlorella minutissima, Chlorella mutabilis, Chlorella nocturna, Chlorella ovalis, Chlorella parva, Chlorella photophila, Chlorella pringsheimii, Chlorella protothecoides, Chlorella protothecoides var. acidicola, Chlorella regularis, Chlorella regularis var. minima, Chlorella regularis var. umbricata, Chlorella reisiglii, Chlorella saccharophila, Chlorella saccharophila var. ellipsoidea, Chlorella salina, Chlorella simplex, Chlorella sorokiniana, Chlorella sp., Chlorella sphaerica, Chlorella stigmatophora, Chlorella vanniellii, Chlorella vulgaris, Chlorella vulgaris fo. tertia, Chlorella vulgaris var. autotrophica, Chlorella vulgaris var. viridis, Chlorella vulgaris var. vulgaris, Chlorella vulgaris var. vulgaris fo. tertia, Chlorella vulgaris var. vulgaris fo. viridis, Chlorella xanthella, Chlorella zofingiensis, Chlorella trebouxioides, Chlorella vulgaris, Chlorococcum infusionum, Chlorococcum sp., Chlorogonium, Chroomonas sp., Chrysosphaera sp., Cricosphaera sp., Crypthecodinium cohnii, Cryptomonas sp., Cyclotella cryptica, Cyclotella meneghiniana, Cyclotella sp., Dunaliella sp., Dunaliella bardawil, Dunaliella bioculata, Dunaliella granulate, Dunaliella maritime, Dunaliella minuta, Dunaliella parva, Dunaliella peircei, Dunaliella primolecta, Dunaliella sauna, Dunaliella terricola, Dunaliella tertiolecta, Dunaliella viridis, Dunaliella tertiolecta, Eremosphaera viridis, Eremosphaera sp., Ellipsoidon sp., Euglena spp., Franceia sp., Fragilaria crotonensis, Fragilaria sp., Galdieria sp., Gleocapsa sp., Gloeothamnion sp., Haematococcus pluvialis, Hymenomonas sp., Isochrysis aff galbana, Isochrysis galbana, Lepocinclis, Micractinium, Monoraphidium minutum, Monoraphidium sp., Nannochloris sp., Nannochloropsis sauna, Nannochloropsis sp., Navicula acceptata, Navicula biskanterae, Navicula pseudotenelloides, Navicula pelliculosa, Navicula saprophila, Navicula sp., Nephrochloris sp., Nephroselmis sp., Nitschia communis, Nitzschia alexandrina, Nitzschia closterium, Nitzschia communis, Nitzschia dissipata, Nitzschia frustulum, Nitzschia hantzschiana, Nitzschia inconspicua, Nitzschia intermedia, Nitzschia microcephala, Nitzschia pusilla, Nitzschia pusilla elliptica, Nitzschia pusilla monoensis, Nitzschia quadrangular, Nitzschia sp., Ochromonas sp., Oocystis parva, Oocystis pusilla, Oocystis sp., Oscillatoria limnetica, Oscillatoria sp., Oscillatoria subbrevis, Parachlorella kessleri, Pascheria acidophila, Pavlova sp., Phaeodactylum tricomutum, Phagus, Phormidium, Platymonas sp., Pleurochrysis camerae, Pleurochrysis dentate, Pleurochrysis sp., Porphyridium sp., Prototheca wickerhamii, Prototheca stagnora, Prototheca portoricensis, Prototheca moriformis, Prototheca zopfii, Pseudochlorella aquatica, Pyramimonas sp., Pyrobotrys, Rhodococcus opacus, Sarcinoid chrysophyte, Scenedesmus armatus, Schizochytrium, Spirogyra, Spirulina platensis, Stichococcus sp., Synechococcus sp., Synechocystisf Tagetes erecta, Tagetes patula, Tetraedron, Tetraselmis sp., Tetraselmis suecica, Thalassiosira weissflogii, and Viridiella fridericiana.

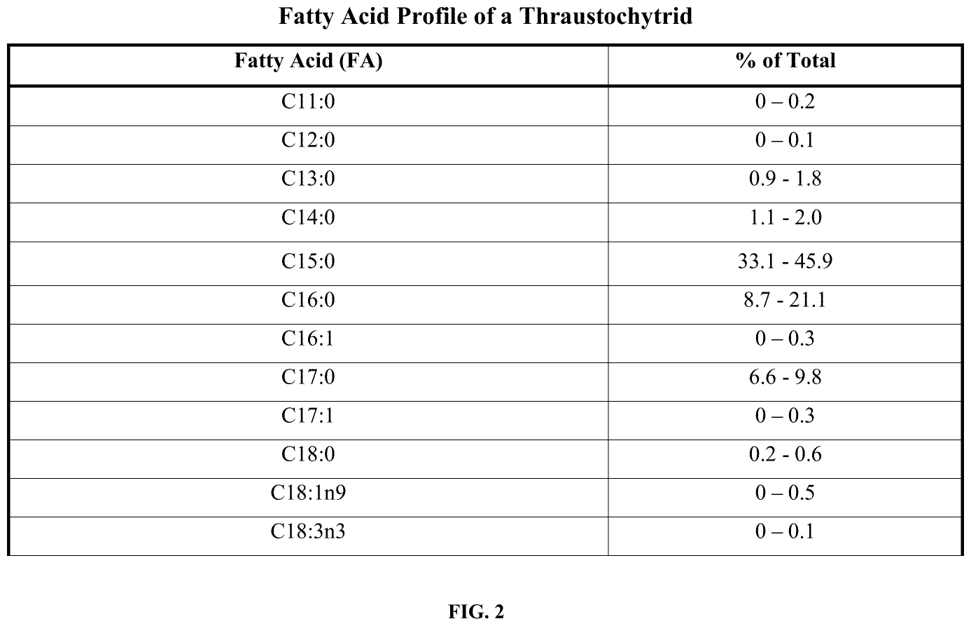

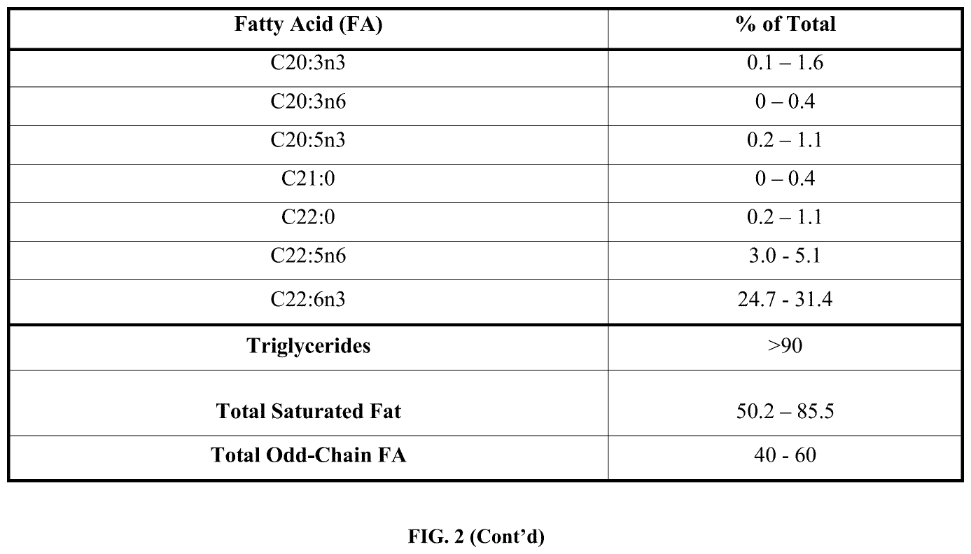

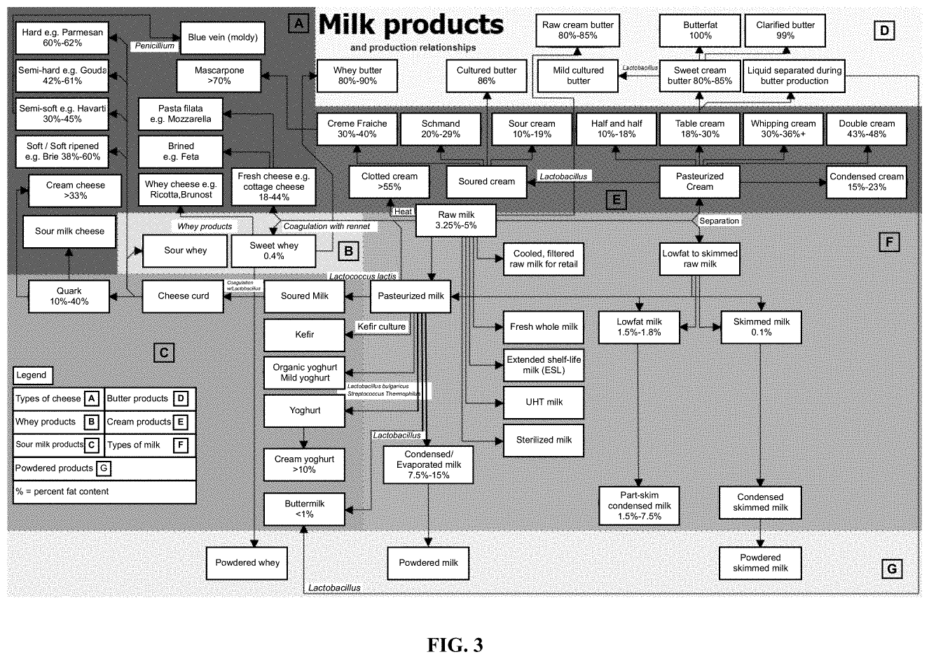

In certain aspects, the source of the microbial anaplerotic oil is a thraustochytrid (i.e., a member of the family Thraustochytriaceae). The thraustochytrid can be any one of Aplanochytrium, Aurantiochytrium, Botryochytrium, Hondaea, Japonochytrium, Labyrinthulochytrium, Labyrinthuloides, Monorhizochytrium Parietichytrium, Schizochytrium, Sicyoidochytrium, Thraustochytrium, or Ulkenia. An example of a fatty acid profile of a thraustochytrid rich in odd chain fatty acids is shown in FIG. 2.

Taxonomic classification has been in flux for organisms in the genus Schizochytrium. Some organisms previously classified as Schizochytrium have been reclassified as Aurantiochytrium, Thraustochytrium, or Oblongichytrium. See Yokoyama et al. Taxonomic rearrangement of the genus Schizochytrium sensulato based on morphology, chemotaxonomic characteristics, and 18S rRNA gene phylogeny (Thrausochytriaceae, Labyrinthulomycetes): emendation for Schizochytrium and erection of Aurantiochytrium and Oblongichytrium gen. nov. Mycoscience (2007) 48:199-211. Those of skill in the art will recognize that Schizochytrium, Aurantiochytrium, Thraustochytrium, and Oblongichytrium appear closely related in many taxonomic classification trees for microalgae, and strains and species may be re-classified from time to time. Thus, for references throughout the instant specification for Schizochytrium, it is recognized that microalgae strains in related taxonomic classifications with similar characteristics to Schizochytrium, such as Aurantiochytrium, would reasonably be expected to produce similar results.

By artificially controlling aspects of the microbial culturing process such as the organic carbon feed (e.g., acetic acid, acetate), oxygen levels, pH, and light, the culturing process differs from the culturing process that microalgae experiences in nature. In addition to controlling various aspects of the culturing process, intervention by human operators or automated systems occurs during the non-axenic mixotrophic culturing of microalgae through contamination control methods to prevent the inoculated microalgae from being overrun and outcompeted by contaminating organisms (e.g., fungi, bacteria or unwanted microalgae). Contamination control methods for microalgae cultures are known in the art and such suitable contamination control methods for non-axenic mixotrophic microalgae cultures are disclosed in W02014/074769A2 (Ganuza, et al.), hereby incorporated by reference. By intervening in the culturing process, the impact of the contaminating microorganisms can be mitigated by suppressing the proliferation of containing organism populations and the effect on the microalgal cells (e.g., lysing, infection, death, clumping). Thus, through artificial control of aspects of the culturing process and intervening in the culturing process with contamination control methods, the culture produced as a whole and used in the described inventive compositions differs from the culture that results from a culturing process that occurs in nature or would take place without the disclosed contamination control interventions.

In certain aspects, the microorganisms (e.g., microalgae) are cultured under mixotrophic conditions to produce anaplerotic oil. Mixotrophic culture conditions are described in WO 2014/074769, WO 2017/132204, WO 2018/064036, and WO 2018/064037. In other aspects, the microorganisms (e.g., microalgae, fungi, or yeast) are cultured in media containing propionate or a precursor thereof to increase production of odd chain fatty acids as described in U.S. Pat. No. 10,745,724. Examples of precursors include but are not limited to propionic acid (e.g., and or one or more propionates, such as the anion, salts, and/or esters of propionic acid), proteose peptone, yeast extract, valine, isoleucine, methionine, pentanoate, and heptanoate.

In one aspect, the microbial anaplerotic oil rich in odd-chain fatty acids is obtained from Aurantiochytrium acetophilum HS399. The Aurantiochytrium acetophilum HS399 strain was deposited on Sep. 12, 2019 with the Bigelow National Center for Marine Algae and Microbiota (NCMA), located at 60 Bigelow Drive, East Boothbay, Me. 04544, USA and assigned Accession No. NCMA 201909001. The deposit was made under the terms of the Budapest Treaty on the International Recognition of the Deposit of Microorganisms for the Purposes of Patent Procedure.

In certain aspects, the microbial anaplerotic oil is added to the dairy products disclosed herein with an emulsification agent. Such emulsification agents include monoglycerides, diglycerides, acacia gum, lecithin, and combinations thereof. In other aspects, the microbial anaplerotic oil is added to the dairy products disclosed herein without an emulsification agent.

Thus, in one embodiment, the defatted animal milk is skim milk or pasteurized skim milk.

In certain aspects, the defatting of the raw milk and the addition of the microbial anaplerotic oil is carried out with the following process:

Step 1: The defatted milk is pasteurized at about 70° C. for about 1 minute.

Step 2: The pasteurized milk and the microbial anaplerotic oil is emulsified using a basic emulsion technique of the microbial anaplerotic oil and the water of the milk. To that end, mixing equipment is used which operates at between about 1,000 and 3,000 rpm, stirring the mixture until the tests performed confirm the stabilization of the emulsion. The microbial anaplerotic oil can be previously mixed with curds and industrial additives to provide aroma and flavors.

Step 3: From step 2, all operations are similar to current procedures for obtain cheeses curds, and other dairy products, such as heating the milk at 35-40° C., incorporating calcium chloride, incorporating the corresponding ferments and curds to prepare the desired dairy product.

In some embodiments, docosahexaenoic acid (DHA) is removed from the microbial anaplerotic oil prior to its addition to the defatted animal milk. In certain aspects, at least 1%, at least 5%, at least 10%, at least 20%, at least 30%, at least 40%, at least 50%, at least 60%, at least 70%, at least 80%, at least 90%, at least 95%, at least 96%, at least 97%, at least 98%, or at least 99% of the DHA is removed from the microbial anaplerotic oil. In other aspects, between 1% and 100%, between 5% and 100%, between 10% and 100%, between 20% and 100%, between 30% and 100%, between 40% and 100%, between 50% and 100%, between 60% and 100%, between 70% and 100%, between 80% and 100%, or between 90% and 100% of the DHA is removed from the microbial anaplerotic oil.

### Microencapsulation of Microbial Anaplerotic Oil

In some aspects of the present invention, the microbial anaplerotic oil is microencapsulated in a glassy matrix of dairy proteins and glucose. Such a glassy matrix of dairy proteins can be prepared from any dairy protein available and suitable for this purpose, e.g. whey protein, casein, caseinate, milk proteins, β-lactoglobulin, α-lactalbumin, etc. Encapsulation may be carried out using techniques known in the art. In one aspect, the microbial anaplerotic oil is encapsulated in a glassy matrix of dairy proteins as described in WO 2011/008097 A1 of Friesland Brands B.V., NL or can be obtained from FrieslandCampina Kievit under the trade name NIF powder.

The choice of coating for the microencapsulation of the microbial anaplerotic oil is determined by its lack of toxicity, desired particle size, and stability under the processing conditions for animal dairy products. Any conventionally acceptable substantially oxygen-impermeable coating for pharmaceuticals and food products can be used in the present invention. Examples of these coating compositions and methods for microencapsulation are given in U.S. Pat. No. 4,001,140 to Foris et al., which patent is hereby incorporated by reference. Other conventional microencapsulating methods and coating materials are well within the purview of one skilled in the art, and the specific microencapsulating method and coating are not peculiar to the present invention.

In certain aspects, the process of microencapsulation comprises addition of at least one oligosaccharide (e.g., a cyclodextrin), at least one thickening agent or stabilizer (e.g., xanthan gum), and/or at least one protein (e.g., whey protein, pea protein, etc.) to the microbial anaplerotic oil. The mixture is then subjected to homogenization and/or milling followed by drying (e.g., with a spray dryer or drum dryer). The resulting dried material containing the microencapsulated microbial anaplerotic oil is then used in the processes described herein to produce an OCFA-enriched animal dairy product.

Additional methods of microencapsulation are outlined in Kaushik et al., “Microencapsulation of omega-3 fatty acids: A review of microencapsulation and characterization methods,” Journal of Functional Foods (2014), doi: 10.1016/j.jff.2014.06.029; Eratte et al., “Recent advances in the microencapsulation of omega-3 oil and probiotic bacteria through complex coacervation: A review,” Trends in Food Science & Technology (2018) 71:121-131; and Timilsena et al., “Advances in microencapsulation of polyunsaturated fatty acids (PUFAs)-rich plant oils using complex coacervation: A review,” Food Hydrocolloids (2017) 69:369-381.

While microencapsulation of the microbial anaplerotic oil is desirable, it is not required. Microencapsulation of the microbial anaplerotic oil provides the benefits of preventing the oil from oxidizing and producing undesirable tastes and smells in the OCFA-enriched dairy product.

Benefits of Replacing Even Chain Saturated Fatty Acids in Animal Milk with OCFA-Rich Microbial Anaplerotic Oil

Approximately 68% of fatty acids present in whole fat animal milk are even-chain saturated fatty acids (ECFAs) (See Mansson, H. L. Fatty acids in bovine milk fat. Food Nutr Res 52, 1 (2008)). Diets with lower saturated fats are recommended to lower cholesterol levels and the risk of heart disease (See Dietary goals for the United States prepared by the staff of the Select Committee on Nutrition and Human Needs, United States Senate. United States. Washington. U.S. Govt. Print. Off (1977)). In certain aspects, the even chain saturated fatty acids in raw animal milk that are removed by the methods described herein are tetradecanoic (C14:0) acid, hexadecenoic (C16:0) acid, octadecanoic (C18:0) acid, or a combination thereof. This reduction in ECFAs provides the advantage of removing a dietary factor contributing to heart disease.

Addition of OCFA-rich microbial anaplerotic oil to defatted animal milk and dairy products prepared from this milk goes one step further. By increasing OCFA (e.g., tridecanoic (C13:0) acid, pentadecanoic (C15:0) acid, and/or heptadecanoic (C17:0) acid) in the diet, the present invention provides health benefits, including lower risks of inflammation, cardiometabolic diseases, and nonalcoholic steatohepatitis (NASH). These health benefits have been documented in Venn-Watson, S., et al. “Efficacy of dietary odd-chain saturated fatty acid pentadecanoic acid parallels broad associated health benefits in humans: could it be essential?” Sci Rep 10, 8161 (2020). Numerous studies have demonstrated a correlation between increased concentrations of OCFA and lower risks of having or developing obesity and various cardiometabolic and liver diseases (See, e.g., Forouhi, N. G. et al. Lancet Diab Endocrinol 14, 70146-9 (2014); Aglago, E. K. et al. J Lipid Res 58, 1462-1470 (2017); Huang, L. et al. Nutrients 11, 998 (2019); Jimenez-Cepeda, A. et al. Clin Nutr 29, 92-96 (2019); Khaw, K. T., Friesen, M. D., Riboli, E., Luben, R. & Wareham, N. PLOS Med 9, e1001255 (2012); Maruyama, C. et al. J Atheroscler Thromb 15, 306-313 (2008); Matejcic, M. et al. Int J Cancer 143, 2437-2448 (2018); Unger, A. L., Torres-Gonzales, M. & Kraft, J. Nutrients 11, 220 (2019); Yoo, W. et al. PLOS ONE 12, e0189965 (2017); Zhu, Y. et al. Am J Clin Nutr 107, 1017-1026 (2018); Zheng, J. S. et al. Am J Clin Nutr 109, 1527-1534 (2019)). Thus, the addition of OCFA-rich microbial anaplerotic oil provides a valuable health benefit to consumers of the disclosed dairy products.

The present invention is further illustrated by the following examples that should not be construed as limiting. The contents of all references, patents, and published patent applications cited throughout this application, as well as the Figures, are incorporated herein by reference in their entirety for all purposes.

### EXAMPLES

### Example 1. Supplementation of Defatted Animal Milk Products with Microbial Anaplerotic Oil

The preparation of milk products, cream products, whey products, butter products, and cheeses from raw animal milk is outlined in FIG. 2. Processing of cheese, yogurt, and butter are described in greater detail above. Defatting of raw milk, which has a fat content of about 3.25% to about 5%, occurs through any of the methods described herein. The defatting process can remove about 5%, about 10%, about 20%, about 30%, about 40%, about 50%, about 60%, about 70%, about 80%, about 90%, or about 100% of the fat from the raw milk. In some aspects, the defatting process removes about 5% to about 100%, about 25% to about 100%, about 50% to about 100%, about 75% to about 100%, about 5% to about 75%, about 25% to about 75%, about 50% to about 75%, about 5% to about 50%, about 10% to about 50%, or about 25% to about 50% of the fat from the raw milk.

Microbial anaplerotic oil rich in odd-chain saturated fatty acids (OCFA) is then added to the raw milk. The microbial anaplerotic oil is added before pasteurization, before fermentation, before heating, before coagulation with rennet, and/or before separation into skimmed raw milk and cream. Alternatively, the microbial anaplerotic oil is added after pasteurization, after fermentation, after heating, after coagulation with rennet, and/or after separation into skimmed raw milk and cream. In some aspects, the microbial anaplerotic oil is added after heating or pasteurization to prevent degradation of the odd chain fatty acids during the periods of increased temperature.

### OCFA-Enhanced Milk

After defatting the raw animal milk, the defatted raw milk is pasteurized and the microbial anaplerotic oil is then added to prepare skim milk, lowfat milk, or whole milk in which even-chain saturated fatty acids (e.g., octadecanoic (C18:0) acid) has been removed and odd-chain saturated fatty acids (e.g., tridecanoic (C13:0) acid, pentadecanoic (C15:0) acid, and/or heptadecanoic (C17:0) acid) have been added. The defatted, pasteurized milk can also be further processed to prepare condensed or evaporated milk or powdered milk, and the microbial anaplerotic oil is added to the final product after the removal of excess water.

In other aspects, the defatted raw milk is subjected to other methods of removing microorganisms (e.g., UHT, filtration, etc.) and microbial anaplerotic oil is then added to produce extended shelf-life milk (ESL), UHT milk, or sterilized milk.

### OCFA-Enhanced Cream and Butter Products

The defatted raw milk is allowed to separate into cream and skimmed raw milk, and the resulting cream is pasteurized. At this point, the microbial anaplerotic oil can be blended into the pasteurized cream, which is then further processed to make half and half, table cream, whipping cream, or double cream.

In some implementations, the table cream is then used to prepare sweet cream butter, clarified butter, butterfat, or mild cultured butter. The defatted, pasteurized cream to which microbial anaplerotic oil has been added can also be used to prepare ice cream (not shown in FIG. 2).

In certain implementations, the defatted pasteurized cream is fermented with Lactobacillus and microbial anaplerotic oil is added to prepare enhanced soured cream. This enhanced soured cream is then processed to prepare sour cream, cultured butter, Schmand, or Crème Fraiche.

### OCFA-Enhanced Yogurt

After defatting the raw animal milk, the defatted raw milk is fermented (e.g., with Streptococcus thermophilus and Lactobacillus delbrueckii subsp. Bulgaricus). Microbial anaplerotic oil is then added together with other desired additives providing improved taste, color, and texture. The resulting yogurt has lower levels of even-chain saturated fatty acids (e.g., octadecanoic (C18:0) acid) and higher levels of odd-chain saturated fatty acids (e.g., tridecanoic (C13:0) acid, pentadecanoic (C15:0) acid, and/or heptadecanoic (C17:0) acid).

### OCFA-Enhanced Cheese

After defatting the raw animal milk, the defatted raw milk is pasteurized and coagulated with Lactobacillus to produce cheese curd. The microbial anaplerotic oil is added to the cheese curd and, optionally, blended or mixed with the cheese curd. This cheese curd is processed to prepare soft, semi-soft, semi-hard, or hard cheeses with lower levels of even-chain saturated fatty acids (e.g., octadecanoic (C18:0) acid) and higher levels of odd-chain saturated fatty acids (e.g., tridecanoic (C13:0) acid, pentadecanoic (C15:0) acid, and/or heptadecanoic (C17:0) acid).

Alternatively, the defatted raw milk is optionally pasteurized and then coagulated with rennet to prepare fresh cheese (e.g., cottage cheese) to which microbial anaplerotic oil is added. This fresh cheese can be further processed to prepare brined cheese (e.g., Feta) or pasta filata (e.g., Mozzarella).

### Example 2. Addition of Microbial Anaplerotic Oil to Animal Milk in Various Proportions

Bovine milk generally contains approximately 4.2% fat, where 98% of it is in the form of triglycerides. Algal Anaplerotic Oil (AAO), a specific form of microbial anaplerotic oil derived from microalgae, is composed of 95% triglycerides. The differences in the fatty acid profiles of bovine milk and AAO are outlined in Table 4. Similar triglyceride content allows for an easy replacement of bovine fat, high in even chain fatty acids, with AAO, which is high in odd chain fatty acids.

In this example, the animal milk is defatted to produce skim milk, and a mixture of Algal Anaplerotic Oil with bovine milk fat is added back to the milk to produce different products. The replacement of bovine fat with AAO at different ratios was simulated (100%, 50%, 33%, 25%, 22%, and 20% of fat mix) to calculate the final OCFA concentration in a milk serving (244 g or 1 cup) as shown in Table 5. The new fatty acid profiles of the resulting milk products are outlined in Table 6. In Tables 4-6, the total OCFAs refers to the combination of tridecanoic (C13:0) acid, pentadecanoic (C15:0) acid, and heptadecanoic (C17:0) acid.

When replacing 25% of the bovine fat in whole fat milk with AAO, the OCFA content from the new AAO-enriched milk increases from 1.3% to 14.1% total fatty acids (TFA). The recommended dairy daily intake is three servings per day (USDA: Choose my plate). By replacing 25% of the bovine milk fat with AAO, as an example, the average person would consume the recommended daily intake of AAO (i.e., 5.6 g/day).

In other instances, if a dairy product is intended to serve as a single dose vehicle for AAO, then a mixture of 30% bovine milk fat and 70% AAO would provide the recommended AAO daily intake in a single dairy serving.

TABLE 4
Fatty acid profile of bovine milk fat from Månsson 2008 and Algal
Anaplerotic Oil from U.S. Pat. Pub. No. 2020/0138074
expressed as percent by weight of the total fatty acids.

| | Bovine Milk | Algal Anaplerotic Oil |
|---|---|---|
| Fatty Acid | Mean ± SD | Mean ± SD |
| 4:0 | 4.4 ± 0.1 | N/A |
| 6:0 | 2.4 ± 0.1 | N/A |
| 8:0 | 1.4 ± 0.1 | N/A |
| 10:0 | 2.7 ± 0.2 | N/A |
| 12:0 | 3.3 ± 0.2 | N/A |
| 13:0 | N/A | 1.4 ± 0.2 |
| 14:0 | 10.9 ± 0.5 | 1.4 ± 0.0 |
| 15:0 | 0.9 ± 0.0 | 42.6 ± 0.9 |
| 16:0 | 30.6 ± 0.9 | 11.7 ± 1.6 |
| 17:0 | 0.4 ± 0.0 | 8.6 ± 0.6 |
| 18:0 | 12.2 ± 0.4 | 0.3 ± 0.0 |
| 14:1 | 0.8 ± 0.4 | N/A |
| 16:1 | 1.0 ± 0.0 | N/A |
| 18:1 | 22.8 ± 1.0 | N/A |
| 18:2 | 1.6 ± 0.1 | N/A |
| 18:3 | 0.7 ± 0.0 | N/A |
| 18:1 trans | 2.1 ± 0.7 | N/A |
| 22:5 (n-6) | N/A | 3.6 ± 0.1 |
| 22:6 (n-3) | N/A | 28.0 ± 1.0 |
| Other FA | 1.6 ± 0.2 | 2.5 ± 0.3 |
| Total Saturated | 69.4 ± 1.7 | 66.1 ± 1.1 |
| Total OCFAs | 1.3 ± 0.1 | 52.7 ± 0.5 |

TABLE 5

| | Grams of OCFA in one serving of milk | | | | | | | | |
|---|---|---|---|---|---|---|---|---|---|
| | (244 g or 1 cup) using different ratios | | | | | | | | |
| | of bovine milk fat to AAO | | | | | | | | |
| | fat during processing. | | | | | | | | |
| | | Grams of OCFA in one serving | | | | | | | |
| | | of Milk (244 g or 1 cup) | | | | | | | |
| | Fat | Fat Ratio (Bovine Milk Fat/AAO Fat) | | | | | | | |
| Product | (g) | 100/0 | 0/100 | 30/70 | 50/50 | 67/33 | 75/25 | 78/22 | 80/20 |
| 3.25% | 7.93 | 0.10 | 4.17 | 2.92 | 2.14 | 1.44 | 1.12 | 1.00 | 0.92 |
| Whole | | | | | | | | | |
| Fat | | | | | | | | | |
| Milk | | | | | | | | | |
| 2% Fat | 4.88 | 0.06 | 2.57 | 1.80 | 1.32 | 0.89 | 0.69 | 0.61 | 0.57 |
| Milk | | | | | | | | | |
| 1% Fat | 2.44 | 0.03 | 1.28 | 0.9 | 0.66 | 0.44 | 0.34 | 0.31 | 0.28 |
| Milk | | | | | | | | | |

TABLE 6
New milk product fatty acid profiles expressed as percent by weight of the total fatty
acids based on the bovine milk fat to AAO fat ratio in each product.

| | Milk | | Bovine Milk Fat/AAO Fat Ratio | | | | | | |
|---|---|---|---|---|---|---|---|---|---|
| Fatty Acid | Fat | AAO | 30/70 | 50/50 | 67/33 | 72/28 | 75/25 | 78/22 | 80/20 |
| C4:0 | 4.4 | | 1.3 | 2.2 | 2.9 | 3.2 | 3.3 | 3.4 | 3.5 |
| C6:0 | 2.4 | | 0.7 | 1.2 | 1.6 | 1.7 | 1.8 | 1.9 | 1.9 |
| C8:0 | 1.4 | | 0.4 | 0.7 | 0.9 | 1.0 | 1.1 | 1.1 | 1.1 |
| C10:0 | 2.7 | | 0.8 | 1.4 | 1.8 | 1.9 | 2.0 | 2.1 | 2.2 |
| C12:0 | 3.3 | | 1.0 | 1.7 | 2.2 | 2.4 | 2.5 | 2.6 | 2.6 |
| C13:0 | | 1.4 | 1.0 | 0.7 | 0.5 | 0.4 | 0.4 | 0.3 | 0.3 |
| C14:0 | 10.9 | 1.4 | 4.3 | 6.2 | 7.8 | 8.2 | 8.5 | 8.8 | 9.0 |
| C15:0 | 0.9 | 42.6 | 30.1 | 21.8 | 14.7 | 12.6 | 11.3 | 10.1 | 9.2 |
| C16:0 | 30.6 | 11.7 | 17.4 | 21.2 | 24.4 | 25.3 | 25.9 | 26.4 | 26.8 |
| C17:0 | 0.4 | 8.6 | 6.1 | 4.5 | 3.1 | 2.7 | 2.5 | 2.2 | 2.0 |
| C18:0 | 12.2 | 0.3 | 3.9 | 6.3 | 8.3 | 8.9 | 9.2 | 9.6 | 9.8 |
| C14:1 | 0.8 | | 0.2 | 0.4 | 0.5 | 0.6 | 0.6 | 0.6 | 0.6 |
| C16:1 n-7 | 1 | | 0.3 | 0.5 | 0.7 | 0.7 | 0.8 | 0.8 | 0.8 |
| C18:1 cis n-9 | 22.8 | | 6.8 | 11.4 | 15.3 | 16.4 | 17.1 | 17.8 | 18.2 |
| C18:1 trans n-9 | 2.1 | | 0.6 | 1.1 | 1.4 | 1.5 | 1.6 | 1.6 | 1.7 |
| C18:2 cis n-6 | 1.6 | | 0.5 | 0.8 | 1.1 | 1.2 | 1.2 | 1.2 | 1.3 |
| C18:3 n-3 | 0.7 | | 0.2 | 0.4 | 0.5 | 0.5 | 0.5 | 0.5 | 0.6 |
| C22:5 n-6 | | 3.6 | 2.5 | 1.8 | 1.2 | 1.0 | 0.9 | 0.8 | 0.7 |
| C22:6 n-3 | | 28 | 19.6 | 14.0 | 9.2 | 7.8 | 7.0 | 6.2 | 5.6 |
| OCFA | 1.3 | 52.6 | 18.2 | 18.2 | 27.0 | 15.7 | 14.1 | 12.6 | 11.6 |

### Example 3. Preparation of Cow Milk Supplemented with Microbial Anaplerotic Oil

### Background and Experimental Methods

Oils and water generally do not mix, and like the fat found in commercial milk microbial anaplerotic oil contains highly saturated fats that may solidify under room temperature or refrigerated conditions. The goal of this experiment was to determine if homogenization can introduce AAO into an animal milk or a selected milk powder product and make a commercially comparable substitute.

### Preparation and Homogenization of Samples

A high-pressure homogenizer (Nano DeBee 45-4 manufactured by Bee International, Inc.) was used to homogenize AAO into various milk based products to produce fine oil particles that are comparable to those in standard milk under refrigerated storage conditions. Processed milks with lower fat content were used to introduce greater amounts of AAO and target fat content to that in existing products or to even higher fat contents.

The milk products shown in Table 7 were used in this study. A series of milk prototypes was created at fat inclusion rates of 0%, 0.5%, 1%, 2%, 3%, 4%, and 5% (g/g), with and without refined AAO. The amount of AAO to add was calculated based on the fat content of each milk type (see Table 8). Homogenization controls and no-homogenization controls were included for sample sensory analysis and particle size comparison to ensure the process did not affect the initial sample and was comparable to the control commercial milk products.

All homogenized samples were processed at 5,000-5,500 psi. The homogenizer was set up in reverse flow. The samples were weighed into individual bottles and placed in a water bath at 60° C. to ensure the oil had liquefied. The homogenizer used a heat exchanger on the outlet to cool the samples to 10° C. before collection. The samples were analyzed and then stored in a refrigerator.

TABLE 7
Milk products used in the investigation of AAO
supplementation and homogenization.

| | | Fat | Protein |
|---|---|---|---|
| Product | Vendor | Content* | Content* |
| Skim Milk | FAIRLIFE ® | 0.08% | 3.37% |
| Reduced Fat 2% Milk | FAIRLIFE ® | 1.97% | 3.30% |
| Reduced Fat 2% Chocolate Milk | FAIRLIFE ® | 1.97% | 3.30% |
| Whole Milk | FAIRLIFE ® | 3.25% | 3.22% |
| IdaPro ® MPI-90 Milk Protein | Idaho Milk | | |
| Powder | Products | 1.10% | 86% |
| IdaPlus ® 1085 Milk Protein | Idaho Milk | | |
| Powder | Products | 1.10% | 81.90% |

*The fat content and protein content in FAIRLIFE ® milk products reported here were taken from “Milk Facts” (http://milkfacts.info/Nutrition%20Facts/Nutrient%20Content.htm).

TABLE 8
Amounts of AAO added to milk samples containing 0%, 0.5%, 1%, 2%, 3%, 4%, or 5% total fat.

| | AAO Added | AAO added | AAO Added | AAO Added | AAO Added | AAO Added |
|---|---|---|---|---|---|---|
| | to Skim | to Reduced | to Reduced Fat | to Whole | to IdaPro® | to IdaPlus® |
| Total Fat | Milk | Fat Milk | Chocolate Milk | Milk | MPI-90 Milk | 1085 Milk |
| Concentration | (g/100 g) | (g/100 g) | (g/100 g) | (g/100 g) | (g/100 g) | (g/100 g) |
| 5% | 4.92 | 3.03 | 3.03 | 1.75 | 4.96 | 4.96 |
| 4% | 3.92 | 2.03 | 2.03 | 0.75 | 3.96 | 3.96 |
| 3% | 2.92 | 1.03 | 1.03 | — | 2.96 | 2.96 |
| 2% | 1.92 | 0.03 | 0.03 | — | 1.96 | 1.96 |
| 1% | 0.92 | — | — | — | 0.96 | 0.96 |
| 0.5% | 0.42 | — | — | — | 0.46 | 0.46 |
| 0% | — | — | — | — | — | — |

### Sensory Evaluation of Milk Samples

The milk samples were visually rated between 1 and 5 for mixability, viscosity, color, and odor with a score of 1 being least similar to control and a score of 5 being most similar to control. The following criteria were used for visual rating the samples:
Mixability:
   separation or precipitation of components out of solution=1
   consistent, homogenous solution=5
Viscosity:
   decreased and/or inconsistent flowability (i.e., increased thickness or dumpiness)=1
   original flowability similar to control=5
Color:
   altered color (i.e., yellow for milk, white for chocolate milk)=1
   original color (i.e., white for milk, brown for chocolate milk)=5
Odor
   fishy odor=1
   original odor similar to control=5
      Purchased milk products without homogenization were chosen as controls while milk protein powders with homogenization were controls for protein powder derived samples because milk protein cannot dissolve well in water without mechanical mixing.

### Lipid Staining and Particle Size Evaluation

The milk samples with different concentrations of total fat were processed through homogenization and were analyzed using a MACSQUANT® Analyzer 16 flow cytometer (Miltenyi Biotec). The samples were diluted 100 times for all particle analysis and 40 times for lipid staining analysis. Briefly, the instrument settings were adjusted to count most of the particles seen based on size (i.e., forward scatter or FSC). Size calibration beads were used to determine the location of particles measuring approximately 1 micron. For the lipid staining, the samples were stained with Nile Red. Nile Red is a lipophilic stain with an excitation maximum at around 515 nm and an emission maximum of around 590 nm. The particle counts were based on the presence of fluorescence in the 579 nm emission range which indicates binding to lipid droplets in the sample.

### Results

Prior to homogenization, the AAO formed a clearly distinguishable layer on the top of the milk products. However, after homogenization no separation of the AAO from the milk products was observable in any of the samples. Several weeks after storage under refrigerated conditions, the homogenized samples containing AAO remained stable with no observable separation.

The sensory evaluation demonstrated that the viscosity generally increased as more AAO was added to the milk products (see Table 9). However, the viscosities of the samples containing the highest amounts of AAO were similar to that of the whole milk product. Addition of AAO to the white milk products did not alter the color of these products. Only with the reduced fat chocolate milk did AAO addition slightly change the color towards a more light brown or white color. At the highest addition rates, the AAO had a minor effect on odor only in the milk powder products, which had no discernible odor without AAO addition.

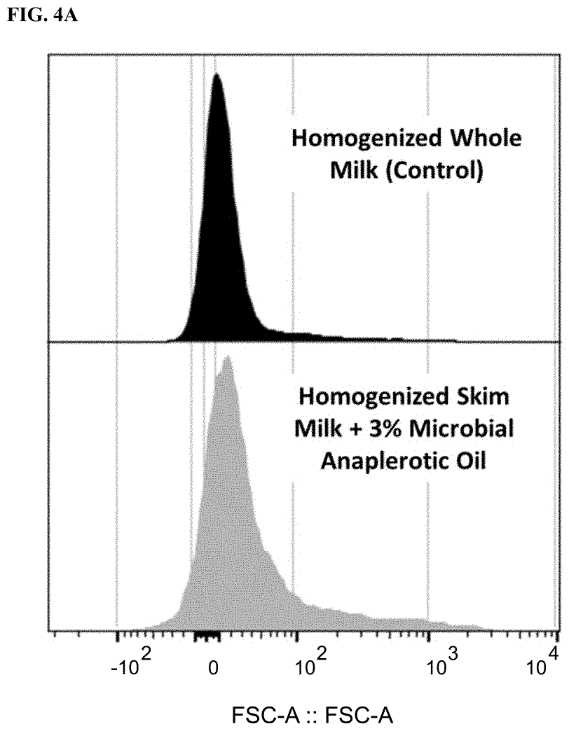

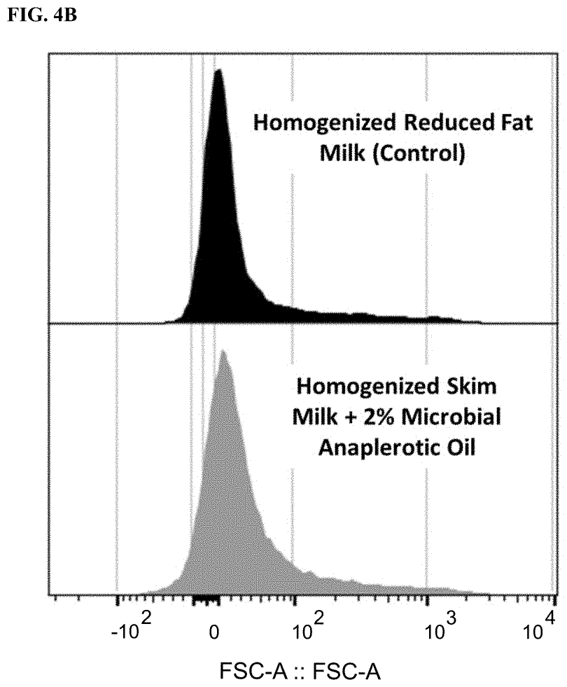

The Nile Red assay generated more counts/mL with increasing amounts of AAO, which validated the assay. Both the Nile Red assay and the particle size analysis indicated similar distributions of particle sizes when comparing the AAO milk samples with their respective controls (see, for example, FIGS. 4A and 4B).

The goal for the project was to introduce AAO into milk based products with varying fat levels targeting 0% to 5%. The high-pressure homogenizer blended the AAO into the existing products without negatively affecting particle size or appearance. The highest levels of AAO began to show some differentiation from those that were lower, but they did not appear very different from whole milk products. The process is a scalable production method that can be integrated into existing equipment. The methods were only modified due to the lab scale homogenizer unit's limited features.

TABLE 9
Scoring of milk samples for sensory analysis properties.
Scoring within in each group is relative to the indicated control.

| | Mix- | Viscos- | | |
|---|---|---|---|---|
| Sample Description | ability | ity | Color | Odor |
| skim milk, unhomogenized - Control | 5 | 5 | 5 | 5 |
| skim milk, homogenized | 5 | 5 | 5 | 5 |
| 0.5% fat in skim milk, homogenized | 5 | 5 | 5 | 5 |
| 1% fat in skim milk, homogenized | 5 | 4 | 5 | 5 |
| 2% fat in skim milk, homogenized | 5 | 4 | 5 | 5 |
| 3% fat in skim milk, homogenized | 5 | 4 | 5 | 5 |
| 4% fat in skim milk, homogenized | 5 | 3 | 5 | 5 |
| 5% fat in skim milk, homogenized | 5 | 3 | 5 | 5 |
| reduced fat milk, unhomogenized - Control | 5 | 5 | 5 | 5 |
| reduced fat milk, homogenized | 5 | 5 | 5 | 5 |
| 2% fat in reduced fat milk, homogenized | 5 | 5 | 5 | 5 |
| 3% fat in reduced fat milk, homogenized | 5 | 5 | 5 | 5 |
| 4% fat in reduced fat milk, homogenized | 5 | 4 | 5 | 5 |
| 5% fat in reduced fat milk, homogenized | 5 | 4 | 5 | 5 |
| reduced fat chocolate milk, unhomogenized - | 5 | 5 | 5 | 5 |
| Control | | | | |
| reduced fat chocolate milk, homogenized | 5 | 5 | 5 | 5 |
| 2% fat in reduced chocolate fat milk, | 5 | 5 | 5 | 5 |
| homogenized | | | | |
| 3% fat in reduced chocolate fat milk, | 5 | 4 | 4 | 5 |
| homogenized | | | | |
| 4% fat in reduced chocolate fat milk, | 5 | 4 | 3 | 5 |
| homogenized | | | | |
| 5% fat in reduced chocolate fat milk, | 5 | 3 | 3 | 5 |
| homogenized | | | | |
| whole milk, unhomogenized - Control | 5 | 5 | 5 | 5 |
| whole milk, homogenized | 5 | 5 | 5 | 5 |
| 4% fat in whole milk, homogenized | 5 | 5 | 5 | 5 |
| 5% fat in whole milk, homogenized | 5 | 4 | 5 | 5 |
| IdaPro ® MPI-90 milk, homogenized - | 5 | 5 | 5 | 5 |
| Control | | | | |
| IdaPro ® MPI-90 milk, unhomogenized | 1 | 5 | 5 | 5 |
| 0.5% fat in IdaPro ® MPI-90 milk, | 5 | 5 | 5 | 5 |
| homogenized | | | | |
| 1% fat in IdaPro ® MPI-90 milk, | 5 | 5 | 5 | 5 |
| homogenized | | | | |
| 2% fat in IdaPro ® MPI-90 milk, | 5 | 5 | 5 | 5 |
| homogenized | | | | |
| 3% fat in IdaPro ® MPI-90 milk, | 5 | 4 | 5 | 5 |
| homogenized | | | | |
| 4% fat in IdaPro ® MPI-90 milk, | 5 | 3 | 5 | 5 |
| homogenized | | | | |
| 5% fat in IdaPro ® MPI-90 milk, | 5 | 3 | 5 | 4 |
| homogenized | | | | |
| IdaPlus ® 1085 milk, homogenized - | 5 | 5 | 5 | 5 |
| Control | | | | |
| IdaPlus ® 1085 milk, unhomogenized | 1 | 5 | 5 | 5 |
| 0.5% fat in IdaPlus ® 1085 milk, | 5 | 5 | 5 | 5 |
| homogenized | | | | |
| 1% fat in IdaPlus ® 1085 milk, homogenized | 5 | 5 | 5 | 5 |
| 2% fat in IdaPlus ® 1085 milk, homogenized | 5 | 5 | 5 | 5 |
| 3% fat in IdaPlus ® 1085 milk, homogenized | 5 | 4 | 5 | 5 |
| 4% fat in IdaPlus ® 1085 milk, homogenized | 5 | 3 | 5 | 4 |
| 5% fat in IdaPlus ® 1085 milk, homogenized | 5 | 3 | 5 | 4 |

Unless defined otherwise, all technical and scientific terms herein have the same meaning as commonly understood by one of ordinary skill in the art to which this invention belongs. Although any methods and materials, similar or equivalent to those described herein, can be used in the practice or testing of the present invention, the preferred methods and materials are described herein. All publications, patents, and patent publications cited are incorporated by reference herein in their entirety for all purposes.

The publications discussed herein are provided solely for their disclosure prior to the filing date of the present application. Nothing herein is to be construed as an admission that the present invention is not entitled to antedate such publication by virtue of prior invention.

All headings and sub-headings are used herein for convenience only and should not be construed as limiting the invention in any way.

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth and as follows in the scope of the appended claims.

### REFERENCES

Winstein, Merryl (2017). SUCCESSFUL CHEESEMAKING™, Step-by-Step Directions and Photos for Making Nearly Every Type of Cheese, (670 pp, 800 photos). St. Louis, Mo.: Smooth Stone Press. ISBN 978-0998595955.
Robinson, R. K.; Wilbey, R. A. (1998). Cheesemaking practice (3rd ed.). Dordrecht: Kluwer Academic.
Banks, J (1998). Cheese (2nd ed.).
Early, R. The technology of dairy products. London: Chapman and Hall.
Jenkins, Steven (1996). Cheese Primer. New York: Workman Publishing.
Tannahill, Reay (2008). Food in History. New York: Three Rivers Press.
Rolf Jost “Milk and Dairy Products” Ullmann's Encyclopedia of Industrial Chemistry, Wiley-VCH, Weinheim, 2002. doi:10.1002/14356007.a16_589.pub3
McGee, Harold (2004). On Food and Cooking: The Science and Lore of the Kitchen. New York, New York: Scribner. ISBN 978-0-684-80001-1. LCCN 2004058999. OCLC 56590708.
“Article on sweet cream, whey cream, and the butters they produce”. Kosher. Archived from the original on 20 Feb. 2012. Retrieved 24 Oct. 2014.
Charles Thom, Walter Fisk, The Book of Cheese, 1918, reprinted in 2007 as ISBN 1429010746, p. 296
Doane, Charles Francis (12 Nov. 2017). “Whey butter”. Washington, D.C.: U.S. Dept. of Agriculture, Bureau of Animal Industry. Archived from the original on 28 May 2017. Retrieved 29 Dec. 2017.
Chandan R C, Kilara A (22 Dec. 2010). Dairy Ingredients for Food Processing. John Wiley & Sons. pp. 1-. ISBN 978-0-470-95912-1.
Farnworth E R (2008). Handbook of fermented functional foods. Taylor and Francis. p. 114. ISBN 978-1-4200-5326-5.
Brown A C, Valiere A (1 Jan. 2004). “Probiotics and medical nutrition therapy”. Nutrition in Clinical Care. 7 (2): 56-68. PMC 1482314. PMID 15481739.
Smith, Andrew (2013). The Oxford Encyclopedia of Food and Drink in America. 2. p. 644. ISBN 9780199739226.
“Milk, whole, 3.25% milkfat”. Self Nutrition Data, know what you eat. Conde Nast. Retrieved 21 Jul. 2015.
“Yogurt, plain, whole milk, 8 grams protein per 8 oz”. Self Nutrition Data, know what you eat. Conde Nast. Retrieved 21 Jul. 2015.
Astrup A (May 2014). “Yogurt and dairy product consumption to prevent cardiometabolic diseases: epidemiologic and experimental studies”. The American Journal of Clinical Nutrition. 99 (5 Suppl): 1235S-42S. doi:10.3945/ajcn.113.073015. PMID 24695891.
Gijsbers L, Ding E L, Malik V S, de Goede J, Geleijnse J M, Soedamah-Muthu S S (April 2016). “Consumption of dairy foods and diabetes incidence: a dose-response meta-analysis of observational studies”. The American Journal of Clinical Nutrition. 103 (4): 1111-24. doi:10.3945/ajcn.115.123216. PMID 26912494.
Rijkers G T, de Vos W M, Brummer R J, Morelli L, Corthier G, Marteau P (November 2011). “Health benefits and health claims of probiotics: bridging science and marketing”. The British Journal of Nutrition. 106 (9): 1291-6. doi:10.1017/5000711451100287X. PMID 21861940.
Moore J B, Horti A, Fielding B A (September 2018). “Evaluation of the nutrient content of yogurts: a comprehensive survey of yogurt products in the major UK supermarkets”. BMJ Open. 8 (8): e021387. doi:10.1136/bmjopen-2017-021387. PMC 6144340. PMID 30228100.
Alting A C, Fred Van De Velde, Kanning M W, Burgering M, Mulleners L, Sein A, Buwalda P (2009). “Improved creaminess of low-fat yogurt: The impact of amylomaltase-treated starch domains”. Food Hydrocolloids. 23 (3): 980-987. doi:10.1016/j.foodhyd.2008.07.011
Hui, ed. Ramesh C. Chandan, associate editors, Charles H. White, Arun Kilara, Y. H. (2006). Manufacturing yogurt and fermented milks (1. ed.). Ames (Iowa): Blackwell. p. 364. ISBN 9780813823041.
Parnell-Clunies E M, Kakuda Y, Mullen K, Arnott D R, Deman J M (1986). “Physical Properties of Yogurt: A Comparison of Vat Versus Continuous Heating Systems of Milk”. Journal of
Dairy Science. 69 (10): 2593-2603. doi:10.3168/jds.S0022-0302(86)80706-8.
“Milk and milk products, 2nd Ed. Codex Alimentarius” (PDF). UN Food and Agriculture Organization and World Health Organization. 2011.
The Culinary Institute of America (2011). The Professional Chef (9th ed.). Hoboken, N.J.: John Wiley & Sons. ISBN 978-0-470-42135-2. OCLC 707248142.
“Oil, canola, nutrients”. FoodData Central. USDA Agricultural Research Service. Retrieved 24 Apr. 2020.
“Nutrient database, Release 25”. United States Department of Agriculture.
Milch.svg: The original uploader was WikiNight at German Wikipedia. Later version(s) were uploaded by Andreas 06, Dapete, Cyrotux at de.wikipedia. (Original text: WikiNight. Übersicht selbst erstellt) Milkproducts.svg: Pschempderivative work: Kbh3rd (talk)-Milch.svgMilkproducts.svg, GFDL, https://commons.wikimedia.org/w/index.php?curid=9879413.
Services, Department of Health & Human. “Milk”. Archived from the original on Oct. 10, 2016. Retrieved Oct. 9, 2016.
Ball, C. Olin (1943). “Short-Time Pasteurization of Milk”. Industrial & Engineering Chemistry. 35 (1): 71-84. doi:10.1021/ie50397a017.
Ranieri, M. L; Huck, J. R; Sonnen, M; Barbano, D. M; Boor, K. J (2009). “High temperature, short time pasteurization temperatures inversely affect bacterial numbers during refrigerated storage of pasteurized fluid milk”. Journal of Dairy Science. 92 (10): 4823-32. doi:10.3168/jds.2009-2144. PMID 19762797.
Wilson, G. S. (1943). “The Pasteurization of Milk”. British Medical Journal. 1 (4286): 261-62. doi:10.1136/bmj.1.4286.261. PMC 2282302. PMID 20784713.
Hui, Y. H.; Meunier-Goddik, Lisbeth; Josephsen, Jytte; Nip, Wai-Kit; Stanfield, Peggy S (2004). Handbook of Food and Beverage Fermentation Technology. p. 265. ISBN 978-0-203-91355-0. Retrieved Sep. 6, 2016.
Stabel, J; Lambertz, A (Apr. 27, 2004). “Efficacy of Pasteurization Conditions for the Inactivation of Mycobacterium avium subsp. paratuberculosis in Milk”. Journal of Food Protection. 67 (12): 2719-26. doi:10.4315/0362-028x-67.12.2719. PMID 15633677. Archived from the original on Sep. 20, 2016. Retrieved Sep. 6, 2016.
“CRS Report for Congress: Agriculture: A Glossary of Terms, Programs, and Laws, 2005 Edition—Order Code 97-905” (PDF). Archived from the original (PDF) on Aug. 10, 2011. Retrieved Jul. 26, 2009.
Maria Markiewicz-Kȩszycka, Grazyna Czyżak-Runowska, Paulina Lipińska, and Jacek Wójtowski (2013) “Fatty Acid Profile of Milk—A Review,” Bull Vet Inst Pulaway 57:135-139.
Helena Lindmark Månsson (2008) Fatty acids in bovine milk fat, Food & Nutrition Research, 52:1, 1821.
Kaushik et al., “Microencapsulation of omega-3 fatty acids: A review of microencapsulation and characterization methods,” Journal of Functional Foods (2014), doi: 10.1016/j.jff.2014.06.029.
Eratte et al., “Recent advances in the microencapsulation of omega-3 oil and probiotic bacteria through complex coacervation: A review,” Trends in Food Science & Technology (2018) 71:121-131.
Timilsena et al., “Advances in microencapsulation of polyunsaturated fatty acids (PUFAs)-rich plant oils using complex coacervation: A review,” Food Hydrocolloids (2017) 69:369-381.

What is claimed is:

1. A method of preparing a defatted animal dairy product enriched with microbial anaplerotic oil, the method comprising:
obtaining raw animal milk;
optionally, pasteurizing the raw animal milk;
defatting the raw animal milk; and
adding microbial anaplerotic oil to the defatted milk to produce an odd-chain fatty acid (OCFA)-enriched dairy product.

2. The method of claim 1, wherein defatting the raw animal milk comprises removing tetradecanoic (C14:0) acid, hexadecenoic (C16:0) acid, octadecanoic (C18:0) acid, or a combination thereof.

3. The method of claim 1, wherein defatting the raw animal milk comprises removing at least 5% of at least one saturated fatty acid from the raw animal milk.

4. The method of claim 1, wherein adding microbial anaplerotic oil comprises adding odd-chain fatty acids to a final concentration of between about 1% and about 100% of the total fat in the OCFA-enriched dairy product.

5. The method of claim 1, further comprising skimming the milk to separate skim milk from cream, wherein a mixture of the microbial anaplerotic oil with animal milk fat from the cream is prepared.

6. (canceled)

7. (canceled)

8. (canceled)

9. The method of claim 5, wherein the mixture is added back to the skim milk.

10. The method of claim 5, wherein the mixture is used to produce cheese, butter, or curd.

11. (canceled)

12. (canceled)

13. (canceled)

14. (canceled)

15. (canceled)

16. (canceled)

17. (canceled)

18. (canceled)

19. (canceled)

20. The method of claim 1, wherein the microbial anaplerotic oil is derived from Aurantiochytrium sp. microalgae.

21. The method of claim 20, wherein the Aurantiochytrium sp. microalgae are Aurantiochytrium acetophilum HS399 having Accession No. NCMA 201909001.

22. The method of claim 1, wherein the microbial anaplerotic oil is microencapsulated.

23. The method of claim 1, wherein the OCFA-enriched dairy product is homogenized.

24. (canceled)

25. The method of claim 1, further comprising adding docasoahexaenoic acid (DHA), eicosapentaenoic acid (EPA), or a combination thereof to the OCFA-enriched dairy product.

26. (canceled)

27. (canceled)

28. An animal dairy product comprising odd-chain fatty acids (OCFA) for consumption by human and non-human animals, the animal dairy product comprising defatted raw animal milk and microbial anaplerotic oil containing OCFA.

29. The animal dairy product of claim 28, wherein the concentrations of tetradecanoic (C14:0) acid, hexadecenoic (C16:0) acid, octadecanoic (C18:0) acid, or a combination thereof are lower than the corresponding concentrations in raw animal milk that has not been defatted.

30. The animal dairy product of claim 28, wherein odd-chain fatty acids are in a concentration of between about 1% and about 100% of the total fat in the dairy product.

31. (canceled)

32. (canceled)

33. (canceled)

34. (canceled)

35. The animal dairy product of claim 28, wherein the microbial anaplerotic oil is derived from Aurantiochytrium sp. microalgae.

36. The animal dairy product of claim 35, wherein the Aurantiochytrium sp. microalgae are Aurantiochytrium acetophilum HS399 having Accession No. NCMA 201909001.

37. The animal dairy product of claim 28, wherein the microbial anaplerotic oil is microencapsulated.

38. (canceled)

39. (canceled)

40. (canceled)

41. (canceled)

42. (canceled)

43. The animal dairy product of claim 28, further comprising docasoahexaenoic acid (DHA), eicosapentaenoic acid (EPA), or a combination thereof.

44. The animal dairy product of claim 28, wherein the animal dairy product is homogenized.
